(19) United States
(12) Patent Application Publication
(10) Pub. No.: US 2009/0207773 A1
(43) Pub. Date: Aug. 20, 2009

(54) MBS SYSTEM, MBS ZONE PARTITIONING METHOD, AND METHOD FOR IMPLEMENTING MBS IN A WIRELESS NETWORK

(75) Inventors: Chengyan FENG, Shenzhen (CN); Zhibin LIN, Shenzhen (CN); Changhong SHAN, Shenzhen (CN); Yong XIE, Shenzhen (CN); Liang GU, Shenzhen (CN); Wenliang LIANG, Shenzhen (CN); Jianjun WU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/360,671

(22) Filed: Jan. 27, 2009

Related U.S. Application Data
(63) Continuation of application No. PCT/CN2007/070402, filed on Aug. 1, 2007.

(30) Foreign Application Priority Data
Aug. 1, 2006 (CN) 200610103985.6
Sep. 5, 2006 (CN) 200610127668.8
Oct. 27, 2006 (CN) 200610143417.9
Apr. 6, 2007 (CN) 200710100531.8

(51) Int. Cl. H04H 20/71

(52) U.S. Cl. 370/312

(57) ABSTRACT

An MBS system, an MBS zone partitioning method, and a method for implementing MBS in a wireless network are disclosed. In the present invention, each MBS zone is managed by an MBS proxy function entity as a signaling plane entity, and the MBS proxy function entity allocates, manages and maintains the resource within the MBS zone. An ASN gateway containing an MBS DPF is adapted to establish, modify, or delete an MBS bear between the MBS DPF and a base station. An MBS agent contained in the base station is adapted to establish the MBS bearer and classifies and distributes MBS packets cooperating with the MBS proxy function entity and the MBS DPF.

### CROSS-REFERENCE TO RELATED APPLICATIONS

This application is a continuation of International Patent Application No. PCT/CN2007/070402, filed Aug. 1, 2007, which claims priority to Chinese Patent Application No. 200610103985.6, filed Aug. 1, 2006, Chinese Patent Application No. 200610143417.9, filed Oct. 27, 2006, Chinese Patent Application No. 200610127668.8, filed Sep. 5, 2006 and Chinese Patent Application No. 200710100531.8, filed Apr. 6, 2007, all of which are hereby incorporated by reference in their entirety.

### FIELD OF THE TECHNOLOGY

The present invention relates to a communication field, and more particularly to a multicast broadcast technique.

### BACKGROUND

Along with the progress of communication technology and subscribers' increasing demands, data service is developed quickly, and due to the rapid increase of the amount of data service, people are in high demand for communication broadband, and the broadband access shows a great potential in the market. To break the bottleneck of broadband for the access network, many broadband access techniques have been developed.

IEEE802.16 was issued by the Institute of Electrical and Electronics Engineers (IEEE) in December, 2001, for providing the standards for wireless broadband access of the last one kilometer in the metropolitan area network. The IEEE802.16 standard mainly includes 802.16a, 802.16RevD, and 802.16e standards.

Worldwide interoperability for microwave access (WiMAX) is a wireless metropolitan area network access technique based on the IEEE 802.16 series standards currently in this field, and is mainly directed to providing an interoperable broadband wireless access means in the metropolitan area network under the multi-vendor environment of one to many.

In specific, the 802.16 series standard specifies that the protocol layer of the air interface in the WiMAX system mainly includes a physical layer (PHY), and a medium access control (MAC) layer. The PHY layer achieves the modulation, demodulation, coding, and decoding operations on the signals in physical, and the MAC layer mainly implements the medium access control function of the WiMAX system.

FIG. 1 shows an end to end reference model of the WiMAX. RI interface is the wireless air interface, and is mainly defined by the IEEE802.16d/e. All the other interfaces are cable interface.

As shown in the figure, WiMAX mainly includes of a mobile station (MS)/a subscribe station (SS), an access service network (ASN), and a connectivity service network (CSN).

The ASN is defined as the network function set for providing wireless access services for the WiMAX subscriber terminal, and includes a base station (BS) and an ASN gateway (ASN-GW) network element. One ASN may be shared by multiple CSNs. The multiple CSNs may respectively belong to different network service providers (NSP). The ASN belongs to a network access provider (NAP). The NSP may be the same provider as the NAP or may be a different provider. The CSN is connected to an application service provider (ASP) network/Internet.

The main function of the ASN includes a BS function and an ASN-GW function. The BS function includes providing L2 connection, a wireless resource management, a measurement and power control, and a compression and encryption of air interface data for the BS and subscribe station SS/MS. The ASN-GW function includes providing a proxy function for the authentication, authorization, accounting function of the SS/MS, supporting network discovery and selection of NSP, providing a relay function of L3 information for the SS, such as IP address allocation and a wireless resource management.

The CSN is defined to provide IP connectivity service for the WiMAX subscriber terminal. The CSN mainly provides the following functions: IP address allocation of the SS/MS; Internet access; authentication, authorization, accounting (AAA) proxy or server; subscriber based authorization control; tunnels from the ASN to the CSN, accounting of the WiMAX subscriber and settlement between the operators; tunnels among the CSNs when roaming; handover among the ASNs; and a variety of WiMAX services, for example, location based service, multimedia multicast and broadcast services, and IP multimedia subsystem services.

The MS/SS is a (mobile) terminal, and is provided for the subscriber to access the WiMAX network.

The WiMAX and its network architecture are described in the above, and the multicast & broadcast service (MBS) is introduced in brief below.

Normally, the communication refers to the communication between one node and the other node. However, along with the increase of subscriber's demand and the import of a variety of media, subscribers need one to many or many to many communication, and consequently a point to multipoint (PTM) transmission mode is put forward. In order to support those modes on the mobile network to implement one to many MBS and also effectively make use of the mobile network resource, the MBS is defined based on the WiMAX in the related art. The MBS is a PTM service that allows one data source to send data to multiple subscribers in the mobile network, thereby realizing the sharing of the network resource and improving the utilization of the network resource, especially the air interface resource. The MBS defined by the WiMAX realizes not only the low rate message multicast and broadcast of plain texts, but also the high speed multicast and broadcast of multimedia services, which undoubtedly complies with the trend of development of mobile data in future.

The MBS based on the WiMAX network supports two access modes, namely, a single base station access and a multiple base station access. In the mode of the multiple base station access, a concept of an MBS zone (identified by MBS_zone ID) is defined. One MBS zone is one set of base stations, and all the base stations in one MBS zone use same multicast connection identifier (Multicast CID) and MBS group security association (MBS GSA) and send the content of the same MBS flow. The terminal registering the MBS may receive the MBS data in the MBS zone through multiple base stations. When the terminal in the idle state moving cross the base stations in the MBS zone, the terminal does not need reconnection and can receive the MBS without influence, thereby realizing the seamless handover of the MBS. The single base station access MBS is a special case of the multiple base station access MBS. The scope of the MBS zone is defined as that all the subscribers receiving the MBS use the same multicast connection identifier in one MBS zone in one base station coverage. The mode of the single base station is not described in detail in the related technologies, but the related technologies describe how the base station sends the MBS data, the terminal receives the MBS data, and the base station informs the terminal of sending the MBS data of interest in the multiple base station mode.

Furthermore, in the Wimax network, the IEEE802.16e protocol specifies that the service flow identifier (SFID) is used to identify a unidirectional service flow, and all the service flows are transmitted at air interface through the connection of the MAC layer, that is, the SFID is mapped to one connection identifier. At the same time, the IEEE802.16e protocol specifies that a multicast connection identifier is used to identify a multicast connection, and an MBS Contents ID is used to identify a multicast content. A protocol data unit (PDU) transmitted on the multicast connection identifier includes one or more multicast broadcast contents.

In the Wimax network, SFID is only used within the ASN, in the interaction between the ASN and the CSN, and within the CSN. For the unicast service, a flow ID (FID) is used to identify the service flow. The two are mapped at the anchor service flow authorization (anchor SFA).

However, in the current Wimax network based on the Wimax technique, i.e. the IEEE802.16e protocol, the corresponding MBS network architecture and the detailed implementation process of implementing the MBS are not defined. That is to say, there is no optimal technique scheme for realizing the MBS in the network.

### SUMMARY

The present invention is directed to a multicast and broadcast service (MBS) system and an MBS zone partitioning method.

Further, the present invention is directed to a method for implementing the MBS in a wireless network, thereby providing a realization scheme for implementing the MBS in a wireless communication network.

The embodiments of the present invention provide an MBS system, which includes an MBS server, an access service network (ASN) gateway and base stations. The system is defined with at least one MBS zone, and each MBS zone includes at least one base station. The system further includes at least one MBS proxy function entity adapted to manage the MBS zone, and each MBS zone is managed by one MBS proxy function entity.

The ASN gateway further includes an MBS data path function (DPF) adapted to establish, modify, or delete an MBS bearer between the MBS DPF and the base station, and the MBS bearer is adapted to transmit an MBS packet to the base station.

The embodiments of the present invention further provide an MBS zone partitioning method. The method includes allocating an MBS zone identifier to a base station set having at least one base station, and providing a same MBS in the base station set with the allocated same MBS zone identifier.

The embodiments of the present invention further provide a method for implementing an MBS in a wireless network. The method includes the following steps.

When the MBS server determines that an MBS is required to be implemented, an MBS server, an MBS proxy including an MBS proxy function entity and an MBS DPF, and an MBS agent interact messages, so as to reserve a network side resource for the MBS.

By using the reserved network side resource, an MBS program provided by an MBS content provider is sent to a subscriber terminal through the MBS server, the MBS proxy, and the MBS agent, or through the MBS proxy and the MBS agent.

After comparison, the technical scheme of the present invention differs from the related art mainly in the following aspects. One signaling plane entity, namely, the MBS proxy function entity is set in each MBS zone, and a subscriber plane entity, namely, the MBS DPF is set in the ASN gateway, thereby realizing the separation of the signaling and the bearer in MBS. The MBS proxy function entity implements an intermediary function between the MBS server and the base station, thereby realizing the bearing and control of the MBS on the MBS server, the ASN gateway, and the base station, and enabling the terminal to receive the MBS of interest in the MBS system.

Furthermore, the present invention defines MBS network architecture, and clarifies the functions of the MBS content provider, the MBS server, the MBS proxy, and the MBS agent included in the MBS network architecture. Therefore, the realization of the present invention is a possible way to implement the MBS in the wireless communication network. At the same time, the realization of the present invention provides a scheme for the wireless communication network to manage the MBS, which guarantees the reliability and continuity of the flow of MBS in the wireless communication network, thereby ensuring the subscriber to enjoy a high efficient and high speed multimedia service in the wireless network.

### BRIEF DESCRIPTION OF THE DRAWINGS

FIG. 1 is a structural view of a WiMAX network;

FIG. 2 is a schematic view of four levels of an MBS network architectural according to embodiments of the present invention;

FIG. 3 is a schematic view of an MBS architectural according to a first embodiment of the present invention;

FIG. 4 is a schematic architectural view of an MS when roaming receiving an MBS provided by a roaming area according to a second embodiment of the present invention;

FIG. 5 is a schematic view of the MBS architectural according to a third embodiment of the present invention;

FIG. 6 a schematic view of a network entity of a first MBS transmission mode according to an embodiment of the present invention;

FIG. 7 a schematic view of a network entity of a second MBS transmission mode according to an embodiment of the present invention;

FIG. 8 is a schematic view of a scheme that an operator configures the MBS zone in a first MBS zone partitioning scheme under a general architecture of MBS according to an embodiment of the present invention;

FIG. 9 is a schematic view of a scheme of automatically configuring the MBS zone in a first MBS zone partitioning scheme under a general architecture of MBS according to an embodiment of the present invention;

FIG. 10 is a schematic view of a scheme that an operator configures the MBS zone in a second MBS zone partitioning scheme under a general architecture of MBS according to an embodiment of the present invention;

FIG. 11 is a schematic view of a scheme of automatically configuring the MBS zone in a second MBS zone partitioning scheme under a general architecture of MBS according to an embodiment of the present invention;

FIG. 12 is a schematic view of a scheme that an operator configures the MBS zone in a third MBS zone partitioning scheme under a general architecture of MBS according to an embodiment of the present invention;

FIG. 13a is a first schematic view of embodied implementation architecture of the MBS system according to the present invention;

FIG. 13b is a second schematic view of embodied implementation architecture of the MBS system according to the present invention;

FIG. 14 is a schematic view of an embodied implementation flow of establishing resources and delivering the MBS at the multicast service network side according to the present invention; and

FIG. 15 is a schematic view of an embodied implementation flow of the MBS according to the present invention.

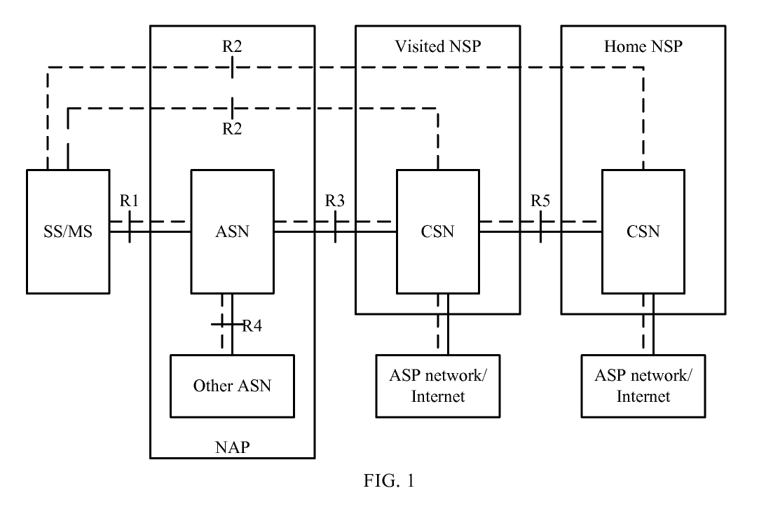

### DETAILED DESCRIPTION

In order to make the objectives, technical schemes, and advantages of the present invention clear, the embodiments of the present invention will be described by reference to the accompanying drawings in detail as follows.

In embodiments of the present invention, an MBS system is mainly described, which includes an MBS server, an MBS Data Path Function (MBS DPF) that is located in an ASN gateway and adapted to process an MBS data plane, and an MBS agent that is located in a base station and adapted to process the MBS data plane, and further includes an MBS proxy function entity that is located in the ASN and adapted to process an MBS signaling plane.

The MBS proxy function entity is a signaling plane entity adapted to manage the MBS zone, which is responsible for allocating, managing, and maintaining resources in the MBS zone, and is unique in the MBS zone. The MBS proxy function entity may have one or any combination of the following functions in detail:

controlling the establishment/modification/deletion of a bearer related to an MBS: mainly for controlling the establishment, modification or deletion of the MBS bearer between the MBS server and the MBS DPF located in ASN gateway, between the MBS DPF located in the ASN gateway and the MBS agent located in the base station, and between the MBS DPFs located in different ASN gateways;

controlling the process of terminal joining and leaving relative to the MBS in the ASN;

allocating parameters and resources related to the MBS, such as a multicast connection identifier (MCID) and a logical channel identifier (Logical CID) for indicating different MBS contents at the air interface link-layer, generating and managing MBS related keys for the air interface encryption defined in the IEEE 802.16e, such as an MGKEK and an MGTEK, and delivering an MBS key to the terminal through the base station after the terminal passes the identity certification and authentication;

when one MBS zone includes multiple MBS DPFs, maintaining an MBS DPF list information that belongs to the same MBS zone;

according to the maintained MBS DPF list, controlling the transmission of the MBS, i.e. controlling the transmission of the MBS on the established bearer;

when supporting a macro diversity of the MBS, uniformly scheduling the MBS related air interface wireless resource in the MBS zone, controlling time synchronization among all the base stations and synchronization of the time-frequency resource among all the MBS agents of the base stations in the same MBS zone; ensuring that the same MBS packets can be sent out in the same wireless frame of all the MBS agents of the base stations in the same MBS zone; in further consideration of the support of the macro diversity, ensuring that the same MBS packets can be sent out at the same wireless air interface resources of the MBS agents of all the base stations in the same MBS zone, in which the same wireless air interface resources include the same wireless frame, the same sub-channel, the same OFDM symbol, and the like; and

according to the quality of service (QoS) requirements related to the MBS, the bearer resource status in the ASN or the MBS zone, and/or the policy of the network access service provider (NAP), performing the decision of MBS resource reservation and the QoS control.

The MBS proxy function entity provides an intermediary function between the MBS server and the base station, thereby realizing the bearing and control of the MBS on the MBS server, the ASN gateway, and the base station, so that the terminal can receive the MBS of interest in the MBS system. The MBS proxy function entity may be directly included in the ASN gateway and implemented by the ASN gateway, or be implemented in an independent network element.

The MBS DPF located in ASN gateway is a subscriber plane entity of the MBS zone, which is responsible for establishing and maintaining the MBS bearer in the MBS zone, i.e. responsible for implementing the establishment, modification, or deletion of the corresponding MBS bearer between the MBS DPF located in the ASN gateway and the MBS agent located in the base station, and/or, responsible for classification and distribution of the MBS packets. The MBS DPF has one or any combination of the following functions in detail:

supporting the establishment, modification, and release of the MBS bearer;

supporting the transmission and classification of the MBS packet;

maintaining identifiers of the MBS proxy function entity of the MBS zone belonged;

supporting MBS accounting;

maintaining a list of MBS agents that belong to the same MBS DPF; and

supporting a synchronization mechanism for MBS air interface MAC PDU, such as adding a synchronization identifier to each MBS packet sent by the MBS DPF to the MBS agent located in the base station, in which the synchronization identifier may be an absolute time tag, an absolute wireless frame number, and a relative wireless frame number, and the like, for guaranteeing that the same MBS packets may be sent out in the same wireless frame or at the same wireless air interface resource of all the MBS agents of the base stations in the same MBS zone.

The MBS agent for handling the MBS data plane located in base station corresponds to the MBS DPF located in ASN gateway, and is adapted to process the establishment and maintenance of the MBS bearer in the base station and the classification and distribution of the MBS packets. The MBS agent has one or any combination of the following functions in detail:

supporting the establishment, modification, or deletion of the MBS bearer;

supporting the data transmission and classification of the MBS data plane;

making a statistic on the number of the subscribers receiving each of the MBS and returning to the MBS proxy function entity or the MBS DPF according to the requirement; and

if supporting the macro diversity, sending the MBS packets to the air interface according to the physical resource information provided by the DPF, for example, sending the MBS packets at the air interface according to the synchronization identifier added in front of the MBS packets by the DPF.

The MBS server includes an MBS Controller and an MBS Content Server, in which the MBS Controller implement the control plane function and the MBS Content Server implement the subscriber plane function. Through the separation of the control plane and the subscriber plane, the service control related operations are independent from and will not impact the service transmission. The MBS Controller and the MBS Content Server coexist in the same physical entity or respectively exist in two physical entities.

The MBS Controller implements one or any combination of the following control plane functions:

allocating an IP multicast address; authenticating the MBS content provider, and controlling the transmission of the MBS content between the MBS content provider and the MBS Content Server; controlling the MBS Content Server to establish or delete the MBS bearer; controlling the MBS Content Server to transmit the MBS; controlling the generation and delivery of an MBS key; and

controlling the start and end of an MBS session; controlling a terminal to join and leave the MBS; saving subscriber signing information of the MBS and/or authenticating and verifying the terminal.

The MBS Content Server implements one or any combination of the following subscriber plane functions: receiving and storing the MBS content from the MBS content provider; combining the MBS from different MBS content providers and delivering the combined MBS through the same multicast source data content according to the requirements; converting the MBS content into a format meeting the session requirement; performing a high-level encryption; and transmitting the MBS under the control of the MBS Controller.

According to the mode of sending service from the MBS server to the MBS zone, the MBS server is required to maintain the MBS DPF lists and the tunnels in all the related MBS zones and directly send the MBS data to the MBS DPF; or maintain the MBS proxy function entity lists of all the related MBS zones and the tunnels of anchors of the MBS DPFs corresponding to each of the MBS zones, and directly send the MBS data to the anchor of the MBS DPF of each MBS zone, and the MBS data is then forwarded by the anchor of the MBS DPF of the MBS zone through an R4 tunnel among the ASNs.

In addition, the system may optionally include an AAA server, a multicast router (MR), and the MBS content provider.

The AAA server is adapted to save subscriber signing information of the MBS and perform the authentication, authorization and accounting on the terminal. The MBS Controller interacts with the AAA server to realize identity certification/authentication of the terminal, and controls the terminal to join or leave the MBS according to the result of the identity certification and/or authentication, thereby preventing an unsigned terminal or a terminal without corresponding rights from receiving the MBS and achieving a better control and management of the MBS. When roaming, the MBS server may interact authentication information/subscriber signing information with a home AAA server of the terminal, so as to perform the authentication/identity certification on the terminal.

The MBS content provider is adapted to provide the MBS content, and may be realized by a third-party content provider or an operator.

The multicast router may be located in the MBS server, and adapted to distribute the MBS; or be located in the ASN gateway or exist independently, and adapted to forward the MBS data according to a multicast address after receiving the MBS data from the MBS Content Server.

The MBS server may be located in the CSN and is dedicated to one CSN. Compared with the related art, this method is easy to implement. Or, the MBS server is located in the ASN, and is shared by at least one CSN. The structure enhances the control of the service and bearer by the MBS server, so that the ASN when shared by the multiple CSNs can allocate system resources in a better way.

Under the above system architecture, the transmission between the MBS server and the data plane function entity MBS DPF located in the ASN gateway may has the following forms.

1. The MBS is transmitted between the MBS server and the MBS DPF in a manner of IP multicast, in which the MBS server allocates a multicast address, establishes a corresponding multicast group, builds the MBS into the IP multicast packet according to the allocated multicast address, and routes the built IP multicast packet to at least one ASN or MBS zone through the multicast router. This method saves many transmission resources, and does not need establishing a point-to-point tunnel.

2. The MBS is transmitted between the MBS server and the MBS DPF in a manner of IP multicast, in which the MBS server allocates a multicast address, establishes a corresponding multicast group, builds the MBS into the IP multicast packet according to the allocated multicast address, transmits the IP multicast packet to at least one border router through the tunnel in a point-to-point manner, and routes the IP multicast packet to at least one ASN or MBS zone by the border router. Because the border router is the first step from the ASN network to the MBS server, the routing range is relatively small. One or more border routers are selected by means of the tunnel, so that the MBS is only transmitted to a range of individual border routers, thereby achieving a better control of the transmission of the MBS in the designated ASN or MBS zone.

3. The MBS is transmitted between the MBS server and the MBS DPF through the tunnel in a point-to-point manner, in which the MBS server allocates a multicast address, establishes a corresponding multicast group, builds the MBS into the IP multicast packet according to the allocated multicast address, and transmits the IP multicast packet to at least one ASN or MBS zone through the tunnel in a point-to-point manner. This method achieves a precise control of the ASN or the MBS zone to which the MBS is transmitted, and is very suitable for providing the MBS within a small range.

4. The MBS is transmitted between the MBS server and the MBS DPF through the tunnel in a point-to-point manner. The MBS server builds the MBS into the IP packet according to the default multicast address or broadcast address, and transmits the IP multicast packet to at least one ASN or MBS zone through the tunnel in the point-to-point manner. This method achieves a precise control of the ASN or the MBS zone to which the MBS is transmitted, and is very suitable for providing the MBS within a small range.

5. The MBS is transmitted between the MBS server and the anchor of the MBS DPF in the MBS zone through the tunnel in a point-to-point manner, and the anchor of the MBS DPF sends the MBS to other MBS DPFs in its governed MBS zone through the tunnel at the R4 interface.

Corresponding to the first to the third transmission forms, the received IP multicast packets can be classified by the MBS DPF according to the classifier of the service flow, and the classified service flows are transmitted respectively through the corresponding tunnels according to the multicast address. Or, the MBS DPF encapsulates the received IP multicast packet in the form that the destination address is the default multicast address or broadcast address, and transmits the encapsulated IP multicast packet through the corresponding tunnel of the default multicast address or broadcast address.

Corresponding to the fourth transmission form, the MBS DPF can directly encapsulate the received IP packet whose destination address is the default multicast address or broadcast address, and transmit the encapsulated IP packet through the tunnel corresponding to the default multicast address or broadcast address.

The MBS may be born by an MBS-grained tunnel between the MBS DPF and the base station, each tunnel uniquely corresponds to one MBS, and the base station distinguishes the MBS according to different tunnel identifiers. Or, if an IP multicast manner is adopted between the MBS server and the MBS DPF, and the service classifier function is implemented on the BS, all the MBSs may be born through a base station-grained tunnel between the MBS DPF and the base station, and the base station distinguishes the MBS according to the multicast address.

The base station bears the MBS at the air interface through the unicast connection or multicast connection corresponding to the MBS.

The tunnel that bears MBS between the MBS DPF and the base station may be pre-established, or is dynamically established when the first terminal joins the MBS or the MBS session starts.

In consideration of the macro diversity, the MBS DPF needs to put some control information and MBS packets into the tunnel and transmit them to the MBS agent in the base station, and then the MBS agent in the base station arranges the sending of the MBS packets according to the control information. The control information may include an absolute time tag, an absolute wireless frame number, a relative wireless frame number, a modulation demodulation method, a modulation demodulation coding method, a frequency subchannel arrangement, mapping of the service data on the frequency subchannel and the OFDM symbols.

In embodiments of the present invention, the MBS is introduced and born in a unit of the MBS zone, and the MBS zone may be partitioned in the following three methods.

When one MBS is introduced into the MBS system, the base stations in the MBS coverage form at least one base station set, and different MBS zone identifiers are allocated to each of base station set. The base stations in the base station set share the allocated MBS zone identifier. This method is the most flexible, and is very suitable for the cases of great difference between different MBS coverage.

Or, the base stations in the MBS system are partitioned into at least one base station set in advance, and when one MBS is introduced thereto, the MBS is simultaneously introduced into at least one base station set. Different MBS zone identifiers corresponding to the MBS are allocated to each base station set, and the base stations in the base station set share the allocated MBS zone identifier. This method is convenient, and is suitable for the case of the minimum coverage of the different MBSs being substantive same.

For the above two methods, when different MBSs are introduced into the same base station or base station set, a different MBS zone identifier corresponding to the MBS needs to be allocated to the base station or base station set, and a different multicast CID needs to be allocated to the MBS zone corresponding to each MBS zone identifier.

Further, the base stations in the MBS system are partitioned into at least one base station set in advance, and different MBS zone identifiers are allocated to each base station set. When the MBS is introduced into the MBS system, the MBS is simultaneously introduced into at least one base station set with the allocated the MBS identifier. The base stations in the base station set share the allocated MBS zone identifier. This method is the most convenient, and there is no need to consider the repetition of the MBS zone identifiers, thereby greatly reducing the information retrieving works. This method is suitable for the area having less MBSs or similar coverage.

For achieving the same MBS zone corresponding to different MBSs in the third method, the multicast CIDs having the same number as the introduced MBSs are allocated to the MBS zone, and each MBS uniquely corresponds to one multicast CID. The different multicast CIDs are used to distinguish the different MBSs.

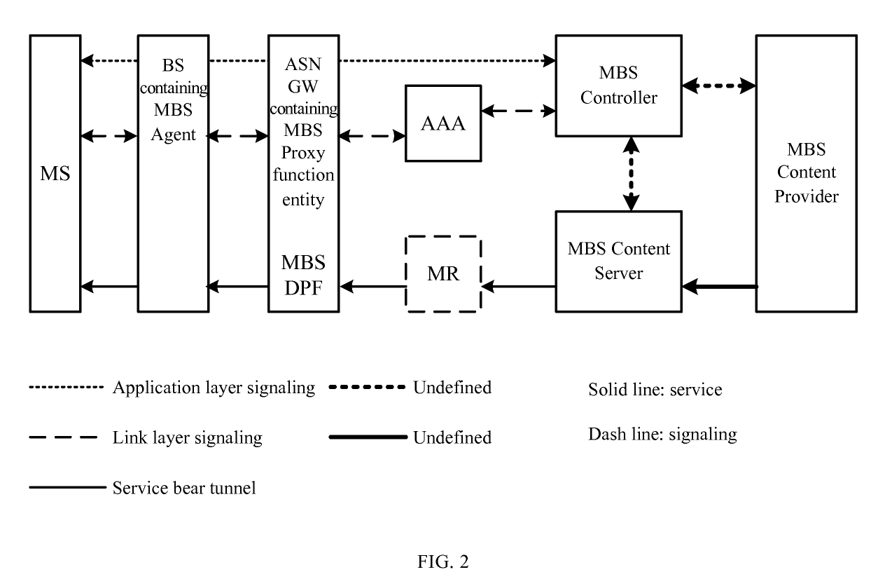

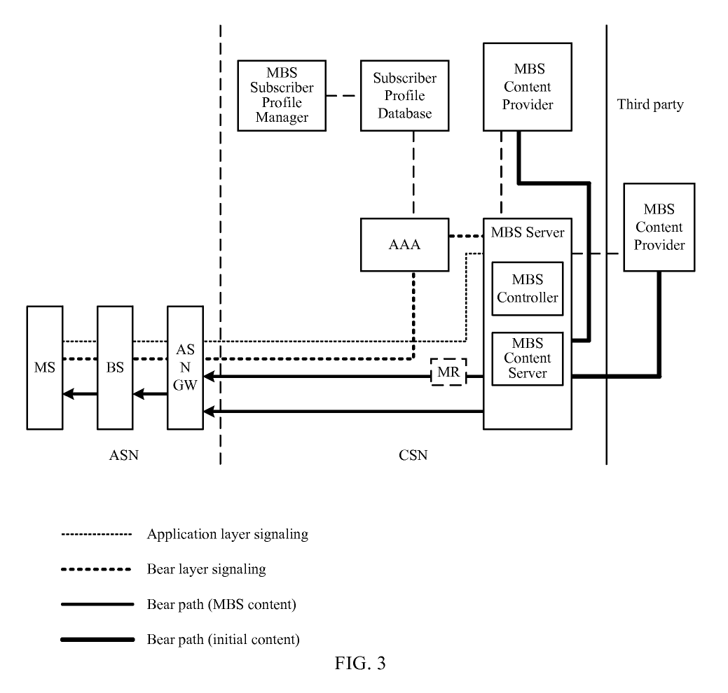

FIG. 2 and FIG. 3 respectively show a schematic view of four levels in an MBS network architectural according to embodiments of the present invention, and a schematic view of an MBS architectural according to a first embodiment of the present invention. In this embodiment, the MBS architecture includes four levels which are an MS, a bearing network, an MBS server, and an MBS content provider, and related interfaces in the architecture. Hereinafter, the related interfaces are first described in brief.

1. Interface between the MBS Controller and the AAA: this interface is adapted for the MBS Controller to acquire subscriber related information from the AAA, and the subscriber related information may include information about the certification authorization and safety, and the subscriber signing information. Meanwhile, the MBS related accounting information needs to be exchanged with the AAA.

2. Interface between the MBS Controller and the MBS proxy function entity: this interface is a part of R3 interface in the WiMAX, and mainly adapted to implement the exchange of the MBS control flow with the MBS proxy function entity, and the MBS control flow includes the processes of service broadcasting, key distribution, session establishment/stopping, subscriber joining/leaving, and so on.

3. Interface between the MBS Controller and the Content Server: this interface is mainly adapted to control the establishment of the service bearer in the Content Server, maintain the information of the service bearer, and the like. If the two functions are implemented in one entity, this interface belongs to an interior interface.

4. Interface between the MBS Controller and the MBS Content Provider: this interface is mainly adapted to control the transmission of the MBS content to the MBS Content Server, and possibly adapted to exchange of information, such as accounting and authentication.

5. Interface between the MBS Controller and the MS: this interface is an application layer interface of the MBS, mainly adapted to exchange the control information such as the MAK key information of the application layer with the subscriber.

6. Interface between the MBS Content Server and the MR: if the IP multicast is adopted to bear the MBS, this interface adopts the IP multicast protocol or the tunnel to send the MBS data.

7. Interface between the MBS Content Server and the Content Provider: this interface is adapted to provide a data path for the MBS from the source to the Content Server.

8. Interface between the MBS Content Server and the MBS DPF: this interface is adapted to provide a multicast data distribution path from the MBS Content Server to the MBS DPF, and may adopt the IP multicast protocol or the tunnel to bear.

9. Interface between the MBS DPF and the MR: this interface adopts the IP multicast protocol to distribute the MBS multicast data.

10. Interface between the MBS proxy function entity and the MR: this interface is responsible for signaling interaction of the IGMP.

11. Interface between the MBS DPF and the MBS agent located in the BS: this interface is adapted to implement the functions related to the MBS control and the sending of the MBS data.

12. Interface between the BS and the MS: this interface is adapted to implement the MBS related air interface function defined in the 802.16e.

Hereinafter, the four levels are respectively described.

The first level is the MS. The MS serves as a terminal for receiving the MBS, and needs interacting with the network to acquire an authorization for allowing receiving the MBS from the network, establishes corresponding resources for receiving the MBS, maintains the corresponding information during the receiving, and returns the situation of the received MBS to the network when necessary.

The second level is a bearing network. The bearing network includes a corresponding part of an access network ASN and the CSN, such as the AAA and the MR. The bearing network mainly functions to provide a signaling bearer and an MBS bearer for establishing the MBS, which includes establishing MBS instance at each node in the network, distributing the MBS data, and managing resource using and allocation of the MBS. It should be pointed out that if the IP multicast group means is used in the MBS transmission, the MR may exist. Hence, the MR is an optional function or equipment in this embodiment.

In specific, in embodiments of the present invention, the bearing network includes four functions, namely, the MBS agent located in the BS, the MBS proxy function entity, the MBS DPF, the AAA and MR which will be illustrated below.

The MBS agent in the BS implements the MBS function defined in the 802.16e, and at the same time interacts with the ASN gateway, accepts the management of the ASN gateway, and further implements the control of the MBS. Furthermore, the MBS agent is responsible for assisting the MS join the MBS multicast service establishment/deletion of the air interface bearer, and the encryption of the link-layer key.

The ASN gateway includes a function of the MBS proxy function entity and the MBS DPF. The MBS proxy function entity implements the control of the MBS in the ASN, and is responsible for the establishment of the MBS session of the terminal. For example, the process of adding or deleting the IP multicast flow needs to be implemented by the ASN gateway. The ASN gateway is the first step of the IP service to the terminal. The ASN gateway is responsible for communicating with the BS, increasing or deleting the IP multicast flow, and may perform the management of the MBS related key and the allocation of the multicast CID, for example, the generation, distribution, and maintenance of the MGTEK.

If there is a need to consider the macro diversity function of the MBS, the MBS proxy function entity is required to implement the synchronization control of the nodes, so as to assist the MBS agent located in the BS to perform the wireless resource scheduling management, realize the synchronous sending of the service content on different BSs. In order to realize the macro diversity, the bearing network interior needs to implement the following functions.

1. Node synchronization: MBS agent which participates the macro diversity and is located in BS is synchronized with the upper-level scheduling node (the MBS proxy function entity and the MBS DPF), each other, and the upper-level scheduling node is required to arrange the sending time and resource. The synchronization of the nodes may be realized by, for example, the GPS.

2. Resource synchronization: the BS is required to use the same resource to send the MBS data. The MBS proxy function entity, the upper-level node of the BS is required for uniformly scheduling resource for the MBS. The scheduling range includes all the BSs in the same MBS zone.

Further, when the data of the upper-level node is informed to the downstream nodes, the data of the upper-level node may precisely achieve all the downstream nodes at the same time, or achieve all the downstream nodes in an acceptable time range. For example, the MBS packets may be sent with the absolute time and the relative time tags.

In order to ensure the delay synchronization of all the nodes, the MBS DPF dynamically detects (such as sending packets to a relative node so as to perform a loop back test to acquire the synchronization delay among all the nodes), or tests when the network is configured, and then configures to the MBS DPF after acquisition. Or, the detection and dynamic adjustment are implemented between the MBS DPF and the BS. For instance, provided that the frame and the frame number between the MBS DPF and the BS are synchronized by the GPS, the delay of achieving the BS may be measured to estimate initially, and accordingly a data is sent to require the BS to send at a certain frame. If the data achieves earlier, the BS sends a response that requires the MBS DPF to send later next time. If the data achieves later, the BS requires the MBS DPF to send earlier. If the data achieves just in time, the BS does not send any feedback, and the dynamic balance is thus achieved.

Further, because the corresponding relation between the DIUC (for informing, by the air interface, the terminal of the index of the coding modulation means adopted by the data required to be received in corresponding data resource area, in which the specific coding modulation method can be found by the terminal according to the index) among each of the base stations in the same MBS zone and the specific coding modulation means may be different. In one means, the MBS proxy function entity directly informs of the specific coding modulation method is required to be adopted by the corresponding MBS packets. Otherwise, the means is to acquire the mapping relations in each of the base stations in advance, thereby different DIUCs are used to indicate for different base stations. Furthermore, the means is to recustomize the DIUC of the MBS, thereby eliminating the possibility that different manufacturers have different mapping relations.

Furthermore, the MBS proxy function entity may need uniformly building and arranging an MBS_MAP in the same MBS zone, a time stamp and a cycle of the MBS_MAP message when it is sent initially, or position indication information of a corresponding MBS_MAP message to be sent by the base station. For example, the position indication information of the MBS-MAP message is indicated by including at least one parameter selected from among an Orthogonal Frequency Division Multiplexing Access (OFDMA) symbol deviation, an OFDMA subchannel deviation, number of the OFDMA symbols, number of the OFDMA subchannel, and the like. The allocation of the DIUC or the building of the MBS_MAP message is also one of the means for scheduling the resource.

The AAA is responsible for performing the authentication certification and accounting on the subscriber who subscribes the MBS, and may also realize the authorization of the MBS. The AAA interacts with the database of the MBS subscription in these processes to acquire profile information of the MBS subscriber, such as whether the subscriber is signed, the detailed situation of the signing, and the situation of the accounting.

The MR is a multicast router that meets the RFC, and may be located in the ASN or the CSN zone, and the like.

The bearing network in this embodiment has the following advantages. First, as described above, if the IP multicast group manner is adopted during the transmission of the MBS, the MR may exist, and the position of the MR is flexible. In specific, the MR may be located in the MBS Content Provider to serve as a function entity for distributing services. The MR may also be located in the ASN gateway, and after the MBS Content Server sends the service data to the ASN gateway, the MR is used to perform distribution. The MR may also be set independently as shown in FIGS. 2 and 3, and becomes an independent entity.

Secondly, referring to FIG. 3, the bearing network further includes an MBS Subscriber Profile Manager and a Subscriber Profile Database. The MBS Subscriber Profile Manager is responsible for maintaining the information details of the subscribed MBSs, e.g., which subscribers subscribe the MBSs and what kinds of MBS have been subscribed, and information ought to be maintained by the operator of the MBSs. The Subscriber Profile Database does not exist due to the MBS, and is equivalent to an information database in the existing system for storing a subscriber signing Profile. For the MBS, the database maintains the information about subscribers who subscribe the MBSs.

The third level is the MBS Server. The MBS Server includes the MBS Controller and the MBS Content Server. The MBS Controller is responsible for handling functions related to the control plane, and the MBS Content Server is responsible for handling functions related to the subscriber plane. It should be pointed out that in this embodiment, the two function entities may be realized in one physical entity, and may also be realized in different physical entities. Sometimes, the MR function or the like may also be included in this level, but should be located in the MBS Content Server for performing the distribution of the multicast data.

In specific, the MBS Controller has five main functions. 1. The MBS Controller manages and provides MBS session information, interacts with the ASN gateway by a V-AAA, interacts with the MS by the ASN gateway and, interacts with the BS by the ASN gateway; and saves session information (correspondence between any two of the following items: the program name, multicast address, the port number and the BCMCS flow IDs, link-layer information such as IP head compression parameter of the service bearer, and further parameters related to the encryption, safety, and the like) of all services. 2. The MBS Controller generates and retains the information about the encryption safety, such as the generation and distribution of the MAK. 3. The MBS Controller assists the MS to discover the expected MBS content information, e.g., provides inquiry of information such as the program and program table for the subscriber. 4. The MBS Controller also has functions of allocating the IP multicast address, designating the port number, and maintaining the managing information of the MBS content, such as start time and cycle of the MBS session, i.e. sending messages such as the session start and service announcement. 5. The MBS Controller authenticates the Content Provider and manages the transfer of the service content from the Content Provider to the Content Server.

The MBS Content Server may be regarded as a assembler for the IP multicast flows, and is capable of storing or assembling the MBS content from the MBS content provider, including combining the contents from different content providers. If a high-level encryption is applied, the MBS server will implement an encryption here. The MBS Content Server converts the content from the service source to a format that meets the session requirement according to the session information of the Controller. Furthermore, if a high-level encryption is required, such as the SRTP, the encryption should be realized in the Content Server.

Further, as described above, in the MBS Server, the MBS Controller and the MBS Content Server may be located in one or two different physical entities. The MBS Server is provided in the CSN, and includes two function entities, namely, the MBS Controller and the MBS Content Server which may be located in one physical entity or different physical entities. If the MBS Controller and the MBS Content Server are located in different physical entities, the two have a corresponding interface.

The fourth level is the MBS Content Provider. This entity is the provider or the source of the MBS content, and may be provided by the content provider of the third-party or provided by the operator, may be several channels of TV signals, or may be all the accounting, control and service content entities of the ICP and the mobile operator interface.

The four levels of the MBS architecture and the related interfaces according to the first embodiment are described above. In this embodiment, the MR is a standard multicast router that meets the IETF RFC, and if the multicast IP flow between the Content Server and the ASN gateway is transmitted through the tunnel, this network element or function may be omitted.

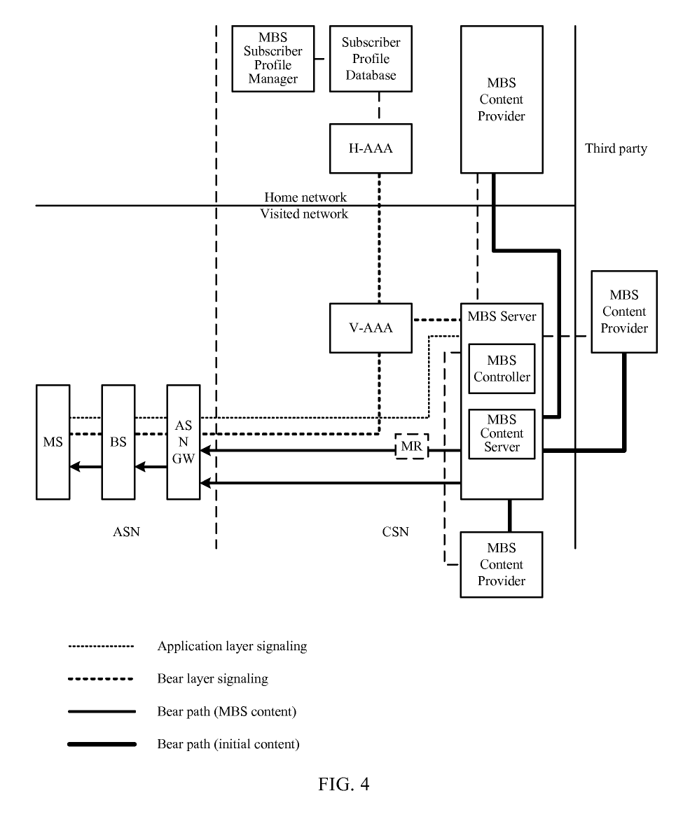

FIG. 4 is a schematic architectural view of an MS when roaming receiving an MBS provided by a roaming area according to a second embodiment of the present invention.

In this embodiment, the architecture of the MBS also includes the MS, the bearing network, the MBS Server, and the MBS Content Provider. The four function parts including the BS, the ASN gateway, the AAA, and the MR in the bearing network, and the functions of the MBS Controller and the Content Server in the MBS SERVER, and interfaces related to the MBS architecture are the same as those in the first embodiment, and the details will not be repeated herein.

In this embodiment, a structure of a roaming MS receiving the MBS provided by the roaming area is described. In specific, because the MBS generally is sent in the predetermined area, when the MS moves to a roaming area, the MS normally cannot receive the MBS provided by the HOME network, but can receive the MBS provided by the roaming area and at this time, the MS needs interacting authentication and signing information with the HOME network. The MS may also subscribe and join the MBS in the roaming area.

If the MBS provided by the HOME network interworks with the MBS Server in the roaming area, in other words, the MBS Content provides the same service, then the MS can enjoy the subscribed service as in the HOME network.

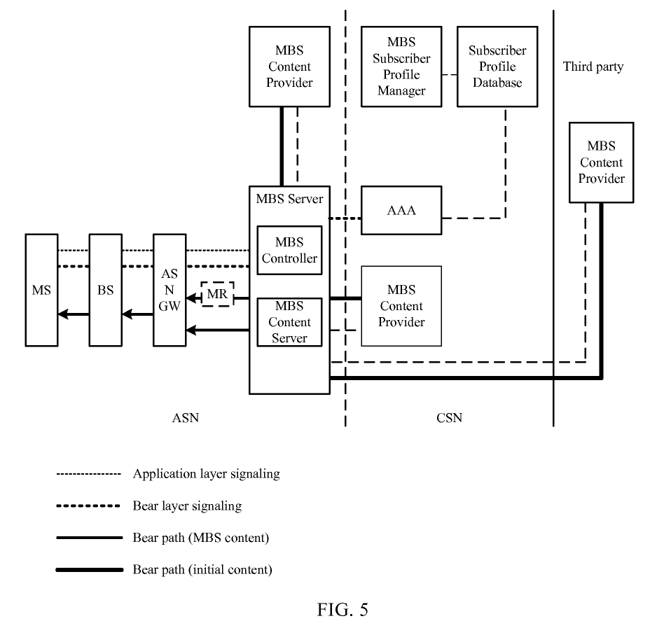

FIG. 5 is a schematic view of the MBS architectural according to a third embodiment of the present invention.

In this embodiment, the architecture of the MBS also includes the MS, the bearing network, the MBS Server, and the MBS Content Provider. The four function parts including the BS, the ASN gateway, the AAA, and the MR in the bearing network, and the functions of the MBS Controller and the Content Server in the MBS SERVER, and interfaces related to the MBS architecture are the same as those in the first embodiment, and the details will not be repeated herein.

Different from the above, in this embodiment, the authorization certification of the subscriber needs to be carried out in the CSN AAA. Meanwhile, the MBS Server is realized in the ASN to serve as a bearing type and service control function provided by the ASN for the CSN to use, which is the major difference of this embodiment from the first and the second embodiment. Meanwhile, in this embodiment, the Content Provider may be provided by the ASN, the CSN, or the third-party.

The structure of this embodiment enhances the performance of the MBS Server in controlling the service and the bearer, so that in the situation that the ASN is shared by multiple CSNs, the system resource may be allocated in a better way.

In embodiments of the present invention, two detailed schemes of the MBS transmission mode and the network entity based on the above MBS architecture are proposed, and will be explained and illustrated below.

An MBS signaling plane refers to a set of signaling behaviors for controlling the MBS. The MBS and the MBS signaling may be realized by many transmission modes such as the tunnel, unicast, and multicast. The following schemes are all applicable to the transmission of the data plane and the signaling plane.

The distinguishing of the signaling plane is directed to directly distinguish the MBS signaling or the MBS at the transmission layer when the entities in the MBS system process the MBS, thereby enhancing the processing efficiency. For example, the MBS Server sends a “Session Start” signaling to the ASN gateway, for informing the start time of the MBS, and triggering the creation of the data plane bearer data path by the access network.

The distinguishing of the MBS signaling plane and the data plane at the transmission layer may be realized by different transmission modes or different IP flows under the same transmission mode. The IP flow refers to an IP data flow that may be uniquely identified by one or more of an IP source address, an IP destination address, a service priority TOS/DSCP, a protocol type, a Flow Label, source port number of the TCP/UDP, destination port number of the TCP/UDP in the IP packet.

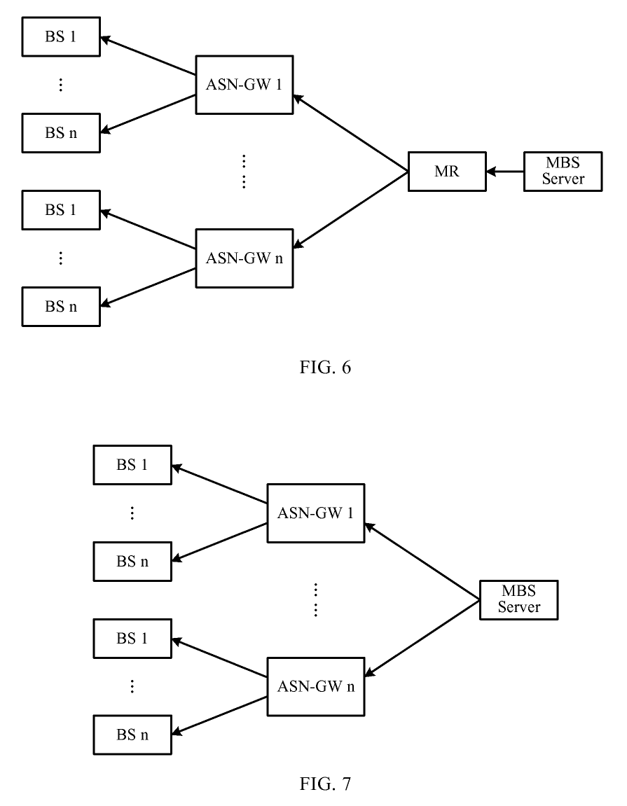

The first MBS transmission scheme is shown in FIG. 6.

In the MBS transmission scheme, the transmission mode between the MBS Server and the ASN gateway is firstly illustrated. The MBS transmission between the MBS Server and the ASN gateway is realized by means of the IP multicast manner. The ASN gateway is required to realize the IP multicast protocol IGMP (IPv4) and MLD (IPv6), and the MBS Server is responsible for allocating the IP multicast address, builds the IP multicast group, and bears different contents on the IP multicast group for transmission.

One IP multicast group may include one or more IP flows having the same IP multicast address. When this IP multicast manner is adopted, the MBS Server can be realized in two ways.

In the first realization means, the IP multicast packet built by the MBS Server is directly routed to one or more ASN networks or MBS zones through a multicast router (MR). In the second realization means, although the MBS Server builds the IP multicast packet, the IP multicast packet will not be directly routed to every ASN network or MBS zone by means of IP multicast routing manner, but is firstly transmitted to one or more border routers through the tunnel and then multicast routed by the border router to one or more access networks.

Meanwhile, when the above IP multicast manner is adopted, the ASN gateway may be realized in three means. In the first realization means, the ASN gateway only serves as the multicast router (MR). In specific, the ASN gateway receives and processes an IGMP Join/Leave message initiated by the MS in uplink direction and at the same time informs the neighboring MRs through the multicast route protocol. In downlink direction, the ASN gateway classifies the received IP multicast packets according to a service flow classifier, and sends the packets to different Data Paths. In the second realization means, the ASN gateway does not serves as the MR, but joins the multicast group as a multicast group member. At this time, the MS is not required to use the IGMP/MLD protocol. After receiving the IP multicast packet, the ASN gateway updates the destination addresses of the IP packet to a default multicast address (all-node multicast address) or broadcast address (v4), and then encapsulates the IP packet and forwards it to a specific Data Path in the ASN. In the third realization means, the ASN gateway serves as not only the MR, but also the multicast group member joining the multicast group, thereby simultaneously providing the MBS for the MSs that supports the IGMP/MLD and does not support the IGMP/MLD. For the MS that supports the IGMP/MLD, the ASN gateway directly forwards the IP multicast data to the MS. For the MS that does not support the IGMP/MLD, the ASN gateway updates the destination address of the received IP multicast packet into the default multicast address (all-node multicast address) or broadcast address (v4), and re-encapsulates and forwards the IP multicast packet to the terminal, so that the IP layer of the MS recognizes and accepts the IP packet. The same service of the two kinds of MSs needs to be born on different Data Paths, so as to be distinguished in the ASN.

The transmission mode between the MBS Server and the ASN gateway in MBS transmission scheme as shown in FIG. 6 has been described in the above, and the transmission mode between the ASN gateway and the BS in the MBS transmission scheme will be described below.

The granularity of the tunnel between the ASN gateway and the BS is based on the MBS granularity, and is unrelated to the MS. Further, one MBS corresponds to one Data Path. The ASN gateway re-encapsulates the received IP data and bears it on the R6 Data Path. In the MBS, the forwarding of data between the ASN gateway and the ASN gateway does not exist.

In this scheme, the ASN gateway distributes different MBSs to different DPs. The BS distinguishes different MBSs according to different DP IDs, and at the same time transmits the services to the terminal at the air interface by using the allocated CID or multicast CID.

It should be pointed out that if the IP multicast manner is adopted between the MBS Server and the ASN gateway, and a service classifier function is implemented on the BS, only one MBS Data Path is required between the ASN gateway and the BS, and all the MBSs are transmitted on this Data Path. The BS recognizes different MBSs according to different multicast addresses, and transmits the services at the air interface by using the allocated CID or multicast CID.

Furthermore, in this scheme, the bearer path between the ASN gateway and the BS may be pre-established, or dynamically established when the first subscriber applies for joining or Session Starts after joining, and is released after the last subscriber leaves.

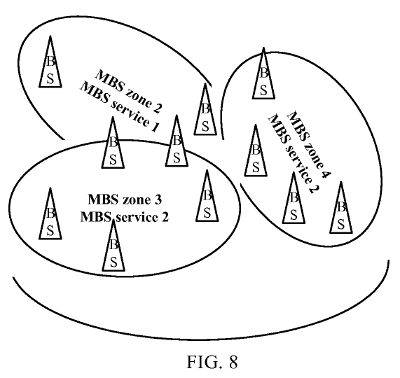

The second MBS transmission scheme is as shown in FIG. 7.

The transmission mode between the MBS Server and the ASN gateway in the MBS transmission scheme should be first illustrated.

The MBS transmission between the MBS Server and the ASN gateway is realized through the tunnel. The ASN gateway and the MBS Server are required to realize the corresponding tunnel protocol, such as L2TP, GRE, and MPLS. Different IP packets transmitted by the MBS Server are transmitted through different tunnels. The same IP packet needs to be sent through different tunnels so as to reach different ASN networks or the MBS zones, and at this time, it is equivalent to that the IP packet is sent multiple times by the MBS Server repetitively.

Under this transmission mode, the MBS Server may be implemented in the following two means.

In the first realization means, the MBS Server bears the upper layer service by means of the IP multicast. The MBS Server is responsible for allocating the IP multicast address, building the IP multicast group, and bears different contents on the IP multicast group for transmission. Different from the first scheme, the built IP multicast packet is transmitted to one or more ASN networks or MBS zones through the tunnel. Accordingly, the ASN gateway distinguishes different MBSs according to different tunnels, thereby encapsulating and forwarding the services to the different Data Paths of the ASN.

At the same time, a corresponding realization means of the ASN gateway includes that the ASN gateway implements the multicast router function, receives and processes the IGMP Join/Leave message initiated by the MS in uplink direction and at the same time informs the neighboring MRs through the multicast route protocol, in downlink direction, the ASN gateway classifies the received IP multicast packets according to the service flow classifier and sends the packets to different Data Paths.

Further, in the second realization means of the MBS Server, the MBS Server does not bear the upper layer service by means of IP multicast. The destination address of the sent IP packet may be the default multicast address (all-node multicast address) or broadcast address (v4). These IP packets are transmitted to one or more ASN networks or MBS zones through the tunnel. In this situation, the corresponding realization means of the ASN gateway includes that the ASN gateway re-encapsulates and forwards the received IP data of different tunnels to different R6 Data Paths, and finally to the terminal.

Further, if the MBS zone is cross multiple ASNs or cross multiple MBS DPFs, the service transmission means between the MBS Server and the MBS zone includes the following two means.

1) The MBS Server performs an independent distribution to each of the MBS DPFs in the MBS zone. If the transmission mode between the MBS Server and the MBS zone is tunnel, the MBS Server needs maintaining an MBS DPF list. If a multicast routing is adopted, the broadcasting scope of the service can only be controlled through a static routing configuration.

2) The service distribution is realized as follows. The MBS Server sends the service to the MBS DPF (e.g. existing on the same ASN GW, or the Anchor MBS DPF in the MBS zone) bound to the MBS proxy function entity in the MBS zone, and sends the service to other MBS PDFs in the zone by the R4 interface. In consideration of supporting the macro diversity, the service distribution especially should be realized as described above. In consideration of the realization of the MBS proxy function entity on the ASN GW, the MBS DPF of the ASN-GW where the MBS proxy function entity is located is equivalent to the Anchor MBS DPF of the MBS. The MBS DPFs on other ASN GWs in the MBS zone are equivalent to Serving MBS DPFs.

The transmission mode between the MBS Server and the ASN gateway in the MBS transmission scheme in FIG. 7 is illustrated in the above. In this scheme, the transmission mode between the ASN gateway and the BS is the same as that of the above scheme, and the details will not be repeated herein. The service and signaling transmission mode between the MBS Server and the ASN gateway, and the service and signaling transmission mode between the ASN gateway and the BS under the general architecture of the MBS provided by the embodiment of the present invention are described in the above. It should be understood that the MBS zones form a distribution area of the MBS, and the different understandings of the MBS zone may be concluded to different schemes of the MBS. Hereinafter, three schemes for partitioning the MBS zone under the general architecture of the MBS provided by the embodiments of the present invention will be illustrated.

In the first scheme, the partitioning of the MBS zone is required to meet the following conditions.

1) One MBS zone corresponds to one MBS, and one MBS may be simultaneously provided in multiple MBS zones. At this time, the MBS zones that belong to one MBS generally do not overlap. One MBS zone of one MBS may include a BS set identical to that of one MBS zone of another MBS.

2) The MBS zone ID should be globally unique. The global area may differ in different partitioning means, which will be illustrated in the description of the partitioning means. The uniqueness of the MBS zone ID has two meanings, that is, although the BS sets of different MBSs are the same, different MBS zone IDs should be allocated to the BS sets, and different MBS zone IDs belonging to one MBS should be different.

3) When one MBS zone is allocated the multicast CID, this multicast CID should be that all the BSs in the MBS zone are idle, i.e. it is not used by other MBSs.

4) One MBS zone has only one MBS, i.e. only one service flow, and only one multicast CID is allocated.

5) One MBS may bear one or more IP flows, i.e. multiple Contents, and when bearing multiple Contents, the logical channel ID needs to be adopted to make further identification at the link-layer (in one multicast CID).

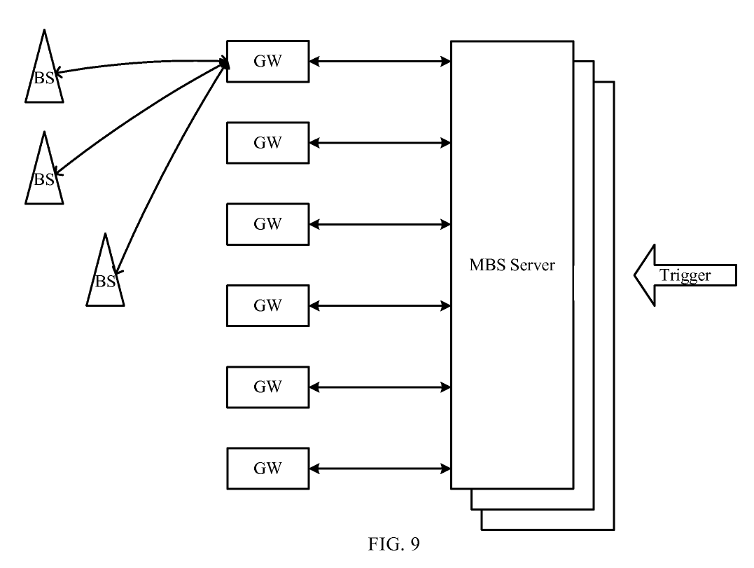

Hereinafter, referring to FIG. 8, a scheme that the operator configures the MBS zone under the above conditions is illustrated.

When the operator needs introducing one MBS, each base station (BS) needs to be configured with an MBS zone ID. Optionally, the multicast CID for transmitting the MBS and signaling needs to be configured for all the base stations in the MBS zone. Then, a uniform security association is established between the terminal and the network according to the configured MBS zone. It should be pointed out that because one BS may belong to different MBS zones of different MBSs at the same time, in the configuring process, the MBS zone IDs need to be ensured to not conflict with one another.

For example, two MBSs, MBS1 and MBS2, need to be sent in the area of FIG. 8. One possible configuration means includes that two MBS zones are partitioned in the global layout area for sending the MBS1, but the zone IDs are different, which are respectively 1 and 2. Likewise, two MBS zones are partitioned in the global layout area for sending the MBS 2, and the zone IDs are ensured to be unique in this layout range, which are respectively 3 and 4. Generally, different zones of the same MBS are not superposed, and different zones of different MBSs may be superposed.

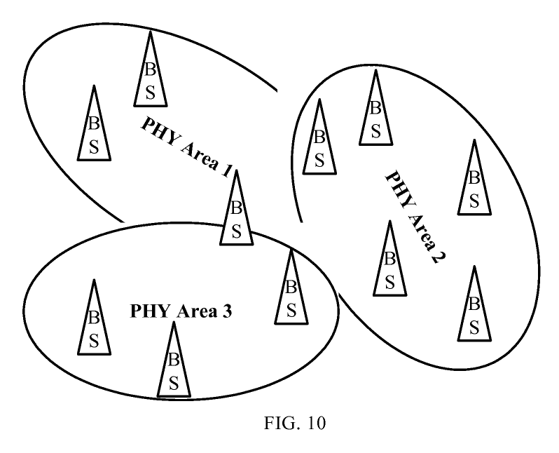

Hereinafter, referring to FIG. 9, a scheme of automatically configuring the MBS zone is illustrated.

For facilitating the ASN to report a busy/idle state of the multicast CID, all the MBS servers join in one specific IP multicast group, and thus, the ASN can inform all the MBS servers by sending one IP packet.

When the operator needs creating a new MBS, it only needs to gives an instruction to the MBS server (which may be from the operator or the content provider of the MBS), the partitioning of the MBS zone and the parameter configuration are done by the MBS server.

In this scheme, it should pay attention to the following points.

1. When the MBS server is triggered, the trigger instruction needs to include the ASN scope interested by the MBS. The MBS server may enquire the interested ASNs for the current resource information (mainly including the allocated MBS zone ID and multicast CID).

2. When an MBS related control entity, which is the MBS agent here (generally located at the ASN gateway) in one ASN, receives an enquiry request of the MBS server, the MBS related control entity make a roll polling to the latest status of the BSs, or directly returns its information as an enquiry response to all the MBS servers. In the latter, its information needs to be consistent with the information of the actual BSs.

3. When the MBS server acquires the latest ASN resource information, different ASNs are come under different MBS zones according to this information, a topology structure of network, and an expected partitioning method of the operator, and the multicast CIDs used in the MBS zones are designated. Further, one MBS zone ID requires to be allocated to each MBS zone, so as to avoid conflicting with the existing MBS zone ID. In details, the means includes ensuring the uniqueness in the global area or may also specify that the MBS zone ID includes some bits indicating which MBS server allocates this MBS zone ID, and thus the global uniqueness can be ensured when the uniqueness is ensured in one MBS server

4. For the convenience of managing, the MBS server may also establish one multicast group for each MBS zone of the current MBS (if only one ASN belongs to this MBS zone, it prefers to select a unicast manner), and the realization includes indicating the MBS agent joining an IP multicast address allocated by the MBS server.

5. When the related ASN accepts the allocation of the MBS server, the ASN spontaneously sends resource (mainly including the multicast CID and the MBS zone ID) so as to update all the MBS servers.

In the second scheme, the partitioning of the MBS zone needs to meet the following conditions.

1) Before the creation of the MBS, a BS set is firstly laid out, and corresponds to one fixed physical area (PHY AREA). If one MBS needs to be sent on one physical area, one MBS zone ID should be allocated to this physical area, and at this time, this physical area is one MBS zone for the MBS. One MBS is sent or born in the unit of MBS zone, i.e. once a BS in a MBS zone may send the MBS, all the BSs in this MBS zone may send this MBS. The multicast CID, the logical channel ID, and the MGSA of the same MBS are consistent in one MBS zone.

2) One MBS may be simultaneously provided in multiple MBS zones. At this time, the MBS zones that belong to one MBS generally do not overlap. If two MBSs are sent on one BS, all the BSs in the physical area, to which this BS belongs, need to send the two MBSs.

3) The MBS zone ID needs to be globally unique. Although the BS set is the same between different MBSs, different MBS zone IDs should be allocated. One MBS may be born in different MBS zones having different MBS zone IDs.

4) One MBS may bear one or more IP flows, i.e. multiple contents. When bearing multiple contents, the logical channel ID is required to be used to make further identification at the link-layer.

5) One physical area may bear multiple MBSs, i.e. the BS in one physical area may have multiple MBS zone IDs.

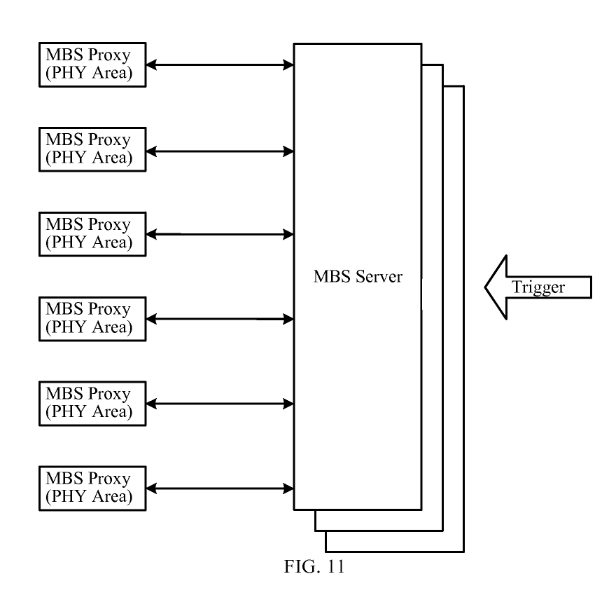

Hereinafter, referring to FIG. 10, a scheme that an operator configures the MBS zone in a second MBS zone partitioning scheme under a general architecture of MBS according to embodiments of the present invention is illustrated.

When the operator needs introducing one MBS, one MBS zone ID is required to be allocated to each set PHY area. The multicast CIDs, which are used for transmitting the MBS and signaling, of all the base stations in the MBS zone is required to be configured by the operator manually, allocated by the MBS server, or allocated by the access network. Then, according to the configured MBS zone, a uniform security association is established between the terminal in the zone and the network. Because one BS may simultaneously belong to different MBS zones of different MBSs, the MBS zone IDs should be ensured to not conflict with one another in the course of configuration.

For example, two MBSs, MBS1 and MBS2, need to be sent in three physical areas of the above figure. One possible configuration means includes that the physical area 1 sends the MBS1, and the corresponding MBS zone ID is 1; the physical area 2 sends the MBS2, and the corresponding MBS zone ID is 2; the physical area 3 sends the MBS1 and MBS2 at the same time, and two corresponding MBS zone IDs are allocated, i.e. 3 and 4.

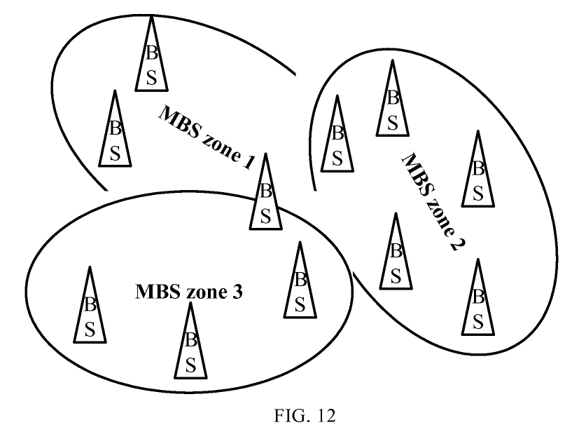

Hereinafter, referring to FIG. 11, a scheme of automatically configuring the MBS zone in the scheme is illustrated.

Different from the first scheme, a granularity for configuring MBS zone is different. In the first scheme, the granularity is the BS, but the granularity of this scheme is several BSs contained in the physical area. As shown in FIG. 11, in one physical area, the multicast CID is uniformly maintained by the MBS proxy, i.e. the multicast CID is allocated by the access network. After receiving the trigger of the MBS activation, the MBS server allocates the MBS to every physical area according to the operator's requirement, and allocates one MBS zone ID related to this MBS for this physical area accordingly. In a detailed example, one NSP has two sets of program lists which are opened for different subscriber groups. Different accounting and QoS policies are applied to different subscriber groups. Most subscribers in the subscriber group 1 are located in the physical areas 1 and 3, and most subscribers in the subscriber group 2 are located in the physical areas 2 and 3. In order to achieve that the subscribers in the subscriber group 1 receive data in the program list 1 only, and the subscribers in the subscriber group 2 receive data in the program list 2 only, two MBS zones may be set in the physical area 3, which use different MBS zone IDs, MCIDs, and SAs, and respectively send the MBS data in different program lists.

In the third scheme, the partitioning of the MBS zone is required to meet the following conditions.

1) One MBS zone corresponds to one fixed physical area. A BS set is firstly laid out, and an MBS zone ID is laid out in advance. One MBS is sent or born in the unit of the MBS zone, i.e. once a certain BS in a certain MBS zone may send the MBS, all the BSs in this MBS zone may send this MBS. The multicast CID, the logical channel ID, and the MGSA of the same MBS are consistent in one MBS zone.

2) One MBS may be simultaneously provided in multiple MBS zones. At this time, the MBS zones that belong to one MBS generally do not overlap. If the zones are overlapping, the BSs at the overlapping zone belong to multiple MBS zones. One MBS zone of one MBS may include a BS set identical to that of one MBS zone of another MBS.

3) The MBS zone ID needs to be globally unique. Although the BS set is the same between different MBSs, the different MBS zone IDs should be allocated. One MBS may be born in different MBS zones having different MBS zone IDs.

4) Multiple multicast CIDs may be allocated in one MBS zone, and one multicast CID corresponds to one MBS or Program (such as binding service) born on this MBS zone.

5) One MBS may bear one or more IP flows, i.e. multiple Contents. When bearing multiple Contents, the logical channel ID is required to be adopted to make further identification at the link-layer.

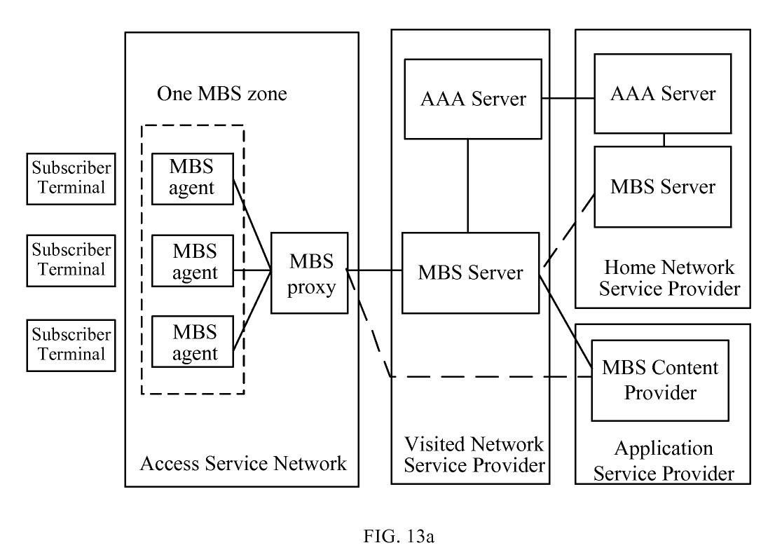

Referring to FIG. 12, it is understood that the MBS zone needs to be configured initially. In the situation of not overlapping, a BS in one MBS zone only has one MBS zone ID. In the situation of overlapping, if a BS is located at the overlapping area of the two MBS zones, the BS has two MBS zone IDs.

In the fourth embodiment of the present invention, one NAP is shared by multiple NSPs. At this time, because the MBS zone is uniformly managed by the NAP, the problem how the MBS zone in the NAP bears the MBS Contents from the MBS Servers of different NSPs that need to be sent in the same physical area should be solved, and the solution for solving the problem includes the following two.

1) In the same physical coverage, different MCIDs are used to bear the MBS Contents from the MBS Servers of different NSPs in the same MBS zone, which is advantageous in the simplified management of the MBS zone.

2) In the same physical coverage, different MBS zones are laid out to respectively bear the MBS Contents from the MBS Servers of different NSPs, which is advantageous in that the air interface resource allocated to one zone is exclusively occupied by one NSP, thereby avoiding resource competition.

In view of the above, in the embodiment of the present invention, one signaling plane entity, namely, the MBS proxy function entity is set in each MBS zone, and a subscriber plane entity, namely, the MBS DPF is set in the ASN gateway, thereby realizing the separation of the signaling and the bearer in the MBS. The MBS proxy function entity implements an intermediary function between the MBS server and the base station, thereby realizing the bearing and control of the MBS on the MBS server, the ASN gateway, and the base station, and enabling the terminal to receive the MBS of interest in the MBS system.

The MBS server is classified into an MBS Controller and an MBS Content Server, in which the MBS Controller implements the control plane function and the MBS Content Server implements the subscriber plane function. Through the separation of the control plane and the subscriber plane, the service control related operations are independent of the service transmission and will not impact the service transmission.

An AAA server is further included. The MBS server interacts with the AAA server to perform an identity certification or authentication on a terminal, which allows the terminal that passes the identity certification or authentication to join the MBS, thereby preventing the unsigned terminal or the terminal without corresponding rights from receiving the MBS, and achieving a better control and management of the MBS.

The MBS key is generated and managed by the MBS server or the ASN gateway, and after the terminal passes the identity certification and/or authentication, the base station delivers the MBS key to the terminal, so that the legal terminal subscriber can receive the corresponding MBS according to the key.

The MBS server may be located in the CSN, and is dedicated to one CSN. This method is easy to implement as compared with the related art. Or, the MBS server is located in the ASN, and is shared by at least one CSN. This structure of this embodiment enhances the performance of the MBS Server in controlling the service and bearer, so that the system resource may be allocated in a better way when the ASN is shared by multiple CSNs.

When roaming, the MBS server may interact with a home AAA server of the terminal for authentication information/subscriber signing information, so as to perform the authentication and/or identity certification on the terminal. This method enables the terminal passing the authentication to receive the corresponding MBS in the roaming area.

The MBS is transmitted between the MBS server and the ASN gateway by means of IP multicast. The MBS server builds the MBS into the IP multicast packet according to the allocated multicast address, and the built IP multicast packet is directly routed to at least one ASN or MBS zone by the multicast router. This method saves many transmission resources, and does not require the establishing of a point-to-point tunnel. However, because the routing scope of the multicast router is broader, the transmission of the MBS is difficult to be controlled in the designated ASN or MBS zone scope.

The IP multicast packet may also be transmitted to at least one border router through the tunnel in a point-to-point manner, and the IP multicast packet is routed to at least one ASN or MBS zone by the border router. Because the border router is the first step from the ASN network to the MBS server, the routing scope is relatively small. One or more border routers are selected by means of the tunnel, so that the MBS is only transmitted to a range of individual border routers, thereby achieving a better control of the transmission of the MBS in the designated ASN or MBS zone.

The MBS may also be transmitted between the MBS server and the ASN gateway directly by the tunnel in a point-to-point manner. This method achieves a precise control of the ASN or the MBS zone to which the MBS is transmitted, and is very suitable for the MBS provided within a small range.

When the MBS is transmitted between the MBS server and the ASN gateway through the tunnel, the IP multicast address may also be allocated, so that the ASN gateway when receiving the IP multicast packet can forward the message according to the multicast address, and the terminal can uniquely confirm the MBS. This method is more applicable, when the terminal simultaneously joins multiple MBSs.

Or, the ASN gateway may encapsulate the IP packet according to the default multicast address or broadcast address, and transmit the MBS in the designated tunnel. This method does not occupy the multicast address resource, and is more applicable to the area in which the terminal only receives one MBS.

The MBS zone may be partitioned in the following three methods.

1. When an MBS is introduced, base stations are dynamically partitioned and form a base station set, and each base station corresponds to one or more MBS zones. This method is the most flexible, and is very suitable for the case of great difference between different MBS coverage. In this method, even if different MBSs correspond to the same base station or base station set, different MBS zone identifiers are also allocated to these base stations or base station sets, i.e. correspond to different MBS zones.

2. The base station set is fixedly partitioned in advance, and when the MBS is introduced, different MBS zone identifiers are allocated to different base station sets, so as to form different MBS zones. This method is convenient but is inflexible, and is suitable for the case of the minimum coverage of the different MBSs being substantive same. In this method, if one base station set corresponds to multiple MBSs, multiple different MBS zone identifiers are allocated to the base station set, so as to form multiple MBS zones.

3. The base station set is fixedly partitioned in advance, and the determined MBS zone identifier is allocated. When the MBS is introduced, the service only needs to be corresponded. This method is the most convenient, and does not consider the repetition of the MBS zone identifiers, thereby greatly reducing the information retrieving works. However, this method is inflexible and is suitable for the area having less MBS or similar coverage.

Further, the present invention further provides a realization scheme of implementing the MBS in the wireless network.

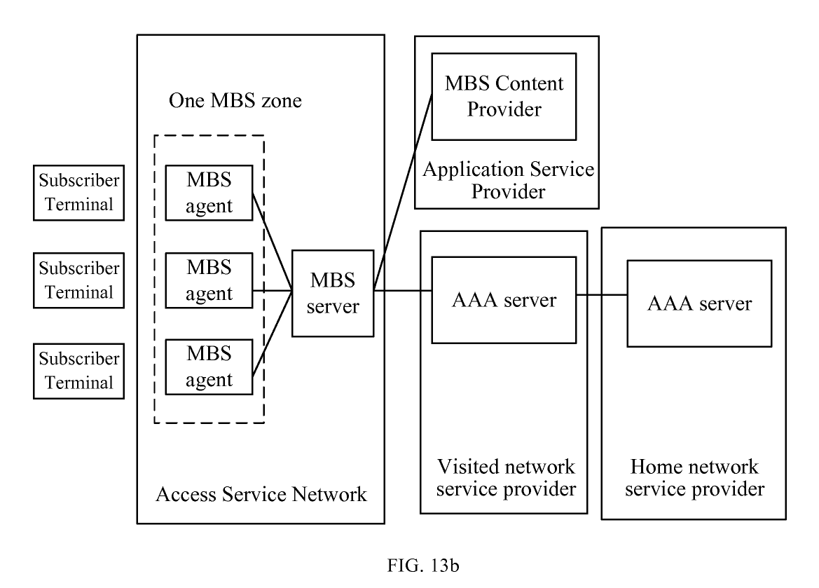

The present invention further provides a system of implementing the MBS in the wireless network. The system includes function units such as an MBS content provider, an MBS server, an MBS proxy, and an MBS agent. The function units are distributed in the function entities at the network side or in a variety of networks, for providing service for the MBS. The network architecture of the system is shown in FIGS. 13a and 13b, and includes the following elements.

1) The MBS content provider, i.e. the MBS provider serves as an MBS program provider, is adapted to provide the detailed MBS content.

The MBS content provider may be arranged in the connectivity service network (CSN) or arranged outside the operator connectivity service network. The MBS content provider may be an operator or a third-party provider.

2) The MBS server is adapted to control the forwarding of the MBS program provided by the MBS content provider to the corresponding MBS proxy.

The MBS server may be arranged in the CSN or bound to a policy function (PF) or exist as an independent function unit, and is a core network element for managing the MBS at the network side. The MBS server is adapted to perform the management and/or scheduling of the MBS session and/or subscriber management and so on, forward the content from the MBS content provider, or combines and forwards the contents from multiple MBS Content Providers.

The MBS server further includes an MBS QoS management unit, when determining that the MBS is required to be implemented, which is adapted to control the message interaction between the MBS server and the MBS proxy, and to reserve resource at the network side for implementing the MBS, so that the reserved resource may be used to provide the MBS for the subscriber terminal. In detail, the management unit is responsible for allocating the multicast parameter information including the MBS content identifier for the MBS, and may be also responsible for allocating the multicast parameter information including the MBS identifier and/or the MBS group security association identifier. The MBS QoS management unit may also be arranged in the MBS proxy and/or the MBS agent, so as to implement corresponding functions.

The MBS server or the AAA server further includes a subscriber management unit, which is adapted to store the MBS signing information of the subscriber and/or the MBS related indication information of the subscriber, or to authenticate an MBS request initiated by the subscriber and provide the support data of accounting and so on. The MBS related indication information may be an MBS activation indication of the terminal, an MBS certification result indication of the terminal, and the like.

The MBS server and/or the MBS Content Provider further include an MAK management unit, which is adapted to generate and/or manage the MBS authorization key and context thereof. The MBS authorization key may be managed in the following three manners. The MBS Content Provider generates and manages the authorization key, and sends the authorization key to the MBS agent. Or, the MBS Content Provider generates the authorization key, and sends the authorization key to the MBS server for management. Or, the MBS server generates and manages the authorization key.

The MBS server further includes a session and transmission management unit, which is adapted to manage the session and transmission of the MBS. When the subscriber joins the network, the preset MBS is initiated, or non-preset MBS is initiated according to a request.

The MBS server and/or the MBS Content Provider further includes an MBS program menu service unit, which is adapted to provide an MBS program list in region to the subscriber, and trigger the service activation function of the subscriber management according to the choice of the subscriber. The MBS program menu service unit may adopt a universal protocol, such as http, to interact with the subscriber.

In the network architecture of the system, the MBS server of the roaming network may optionally directly communicate with the MBS server of the home network, as shown by the dashed line in FIG. 13a.

3) The MBS proxy serves as a center node of the MBS at the network side, and is adapted to control the sending of the MBS program sent by the MBS server or the MBS content provider to the corresponding MBS agent.

The MBS proxy may be arranged in the access service network (ASN) zone, or arranged at the ASN gateway, or bound to the Service Flow Authorization (SFA), or exist as an independent function unit. The MBS proxy is the center node of the MBS at the network side, and includes a subscriber plane and a control plane.

The MBS proxy further includes a key management unit adapted to manage the safe key of the MBS and context thereof. The safe key includes an MBS Group Traffic Encryption Key (MGTEK), and/or an MBS Authorization Key (MAK), and/or an MBS Traffic key (MTK).

The MBS proxy further includes an MBS zone management unit adapted to manage and maintain one MBS zone, and further adapted to perform the synchronization of the MBS in one MBS zone.

The MBS proxy further includes an MBS QoS management unit. When determining that the MBS requires be implemented, the MBS QoS management unit is adapted to control the message interaction between the MBS proxy and the MBS agent and reserve resource in the ASN for implementing the MBS, so that the corresponding reserved resource may be used to provide the MBS for the subscriber terminal. In detail, the management unit allocates the MBS parameter information including the multicast connection identifier for the MBS, and may also allocate other multicast parameter information that is not allocated by the MBS server, including the MBS identifier and/or the MBS group security association identifier, for the MBS, thereby acquiring the complete multicast parameter information that needs to be sent to the MBS agent, and sending it to the MBS agent.

Further, the MBS zone management unit and the MBS QoS management unit may also be combined into one function unit.

(4) The MBS agent serves as the MBS implementing entity for one MBS zone, and is adapted to provide the MBS program to the subscriber terminal according to the received MBS program.

The MBS agent may be arranged in the base station (BS), or bound to the service flow management (SFM), or exist as an independent function unit.

The MBS agent further includes an MBS QoS management unit. When determining that the MBS is required to be implemented, the MBS QoS management unit is adapted to control the message interaction between the MBS proxy and the MBS agent, and between the MBS agent and the subscriber terminal, to reserve resource at the network side for implementing the MBS, and to inform the subscriber terminal of the reserved resource, so that the corresponding reserved resource may be used to provide the MBS to the subscriber terminal.

The MBS agent further includes a key management unit adapted to manage the safe key of the MBS and context thereof. The safe key includes the MTK, and/or the MGTEK, and/or the MAK.

In the present invention, the subscriber terminal setting for receiving the MBS data may also include an MBS key management unit, an MBS QoS management unit, and so on.

If network nodes exist between the MBS proxy and the MBS agent, the function of the network nodes is to converge.

In the system of the present invention, different function units respectively included in the MBS server, the MBS proxy, and the MBS agent may be set independently, and may also be set in combination. For example, the QoS management unit and the session and transmission management unit in the MBS server may be combined into one function unit.

In the system of the present invention, the MBS server and the MBS proxy may be combined as an MBS server. That is to say, the MBS server may also implement the function of the MBS proxy in additions to its own functions, and implement the functions of the MBS server and the MBS proxy in the network. The combined MBS server may be arranged at the original location of the MBS proxy in the ASN zone, or may also be arranged at the original location of the MBS server in CSN.

In the system of the present invention, the MBS content provider may be directly connected to the MBS proxy. The MBS program is sent to the MBS proxy by the MBS content provider directly, and is then forwarded to the next-level function unit by the MBS proxy.

In the system of the present invention, the MBS proxy may be a combination of the MBS proxy function entity and the MBS DPF.

The present invention further provides a method of implementing an MBS in a wireless network. In this method, when the MBS server determines that an MBS is required to be implemented, an MBS server, an MBS proxy, and an MBS agent interact messages, for reserving corresponding resources for the MBS at the network side, i.e. configuring the network side resource for the MBS. The configured network side resource is then used to implement the MBS.

The network side resource includes a bearer resource between the MBS proxy and the MBS agent, and/or between the MBS server and the MBS proxy, or between the MBS content provider and the MBS proxy. The bearer resource includes a tunnel, a data path, and so on.

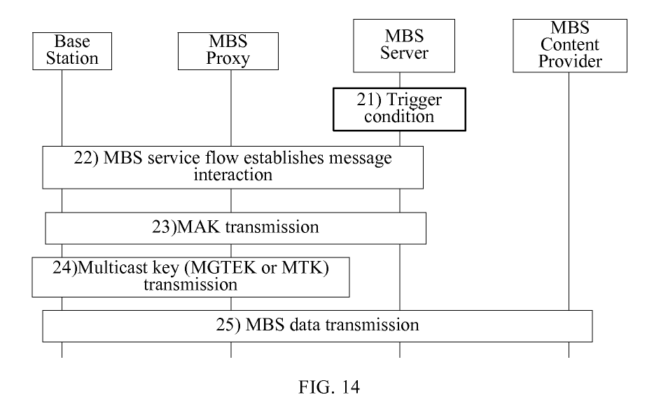

In the method of the present invention, an embodied implementation flow of establishing the multicast service network side resources and delivering the MBS is shown in FIG. 14, and this flow includes the follow steps.

In step 21, the MBS server receives a trigger condition, and triggers the configuration process of the network side resource for the coming MBS.

The trigger condition in this process may be: the MBS server receiving a message from the MBS content provider, which indicates the MBS to be started; or after the MBS server requesting the MBS content provider for the MBS and receiving an indication message of the MBS content provider; or after the MBS server receiving an MBS request message sent from a certain signing subscriber and forwarded by the MBS proxy or other function units; or after the MBS server receiving the MBS request message from a certain signing subscriber.

In step 22, the MBS server, the MBS proxy, and the MBS agent performs the process of message interaction of the MBS establishment. This process includes the configuration and delivery of the multicast resource parameter information, and/or the establishment of the bearer resource such as the tunnel and the data path.

In step 23, the MBS server sends the MBS authorization key (MAK) and context thereof to the MBS proxy or the MBS agent.

In step 24, the MBS proxy generates an MGTEK and context thereof, and sends a part of the multicast safety context to each MBS agent in the MBS zone.

The part of the multicast safety context (i.e. the safe key and context thereof) may be the MGTEK and context thereof (at this time, the MBS server sends the MAK to the MBS agent, and the MBS agent calculates the MTK according to the MAK and the MGTEK), or the MGTEK and context thereof, and the MTK and context thereof (at this time, the MBS server sends the MAK to the MBS proxy, and the MBS proxy calculates the MTK according to the MAK and the MGTEK, and sends the MTK and context thereof to the MBS agent).

The step 23 and/or step 24 may also be combined with the step 22, i.e. the MBS safe key context may be directly delivered in an MBS flow establishment message.

The steps 22, 23 and 24 are not ordered in time sequence, and may be combined with any time sequence. That is to say, the MAK and context thereof may be sent first, and then the MBS flow establishment message is sent, and finally the multicast key (the MGTEK or the MTK) is sent. Or, the MBS flow establishment message is sent first, and the MAK and context thereof are sent, and finally the multicast key (the MGTEK or the MTK) is sent. Other combinations which can be adopted will not be described herein.

In step 25, after the configuration of the multicast resource parameter is completed, the network side starts using the configured network side resource to perform the transmission of the MBS packets, thereby realizing the transmission of the corresponding MBS program.

During the message interaction between the MBS content provider, the MBS server, the MBS proxy, and the MBS agent in the present invention, a point-to-point safe tunnel mechanism may be adopted to perform the message interaction, so as to ensure the safety of the MBS information. According to the actual requirement, tunnels may be completely or partially established between the MBS proxy and the BS, and/or between the MBS proxy and the MBS server, and/or between the MBS server and the MBS content provider, and/or between the MBS proxy and the MBS content provider. That is to say, the tunnels are established between the entities that requires the corresponding safety guarantee.

In the above process, the establishment of the MBS at the network side is irrelated to the subscriber, and the service is established stage by stage. The success of the establishment of a upper-level service does not rely on the feedback of a lower level service.

In the present invention, when determining the MBS is required to be implemented, in addition to triggering the configuration of the network side resource for the coming MBS, the method also includes a process of the MBS server and the MBS proxy allocating multicast parameter information and the multicast safe key context for the MBS.

The details about the allocation of the multicast parameter information are described as follows.

After the MBS server receives a message sent by the MBS content provider, the MBS server allocates the MBS Contents ID for identifying the multicast program for the MBS. Or, the MBS Contents ID may also be allocated by the MBS content provider and then delivered to the MBS server.

In this process, for example, the MBS allocates the MBS Contents ID, and the MBS server may allocate one MBS identifier for all the MBS Contents that need to be transmitted on one PDU when the MBS server is responsible for allocating the MBS Contents ID.

The MBS server may also allocate the MBS group security association identifier (MBS GSA ID), and send it to the MBS proxy.

In the present invention, when the MBS proxy receives the multicast parameter information sent by the MBS server, in order to sent the corresponding multicast parameter information to the MBS agent, a multicast connection identifier (Multicast CID) should be allocated to each MBS zone, and at the same time, the MBS identifier is required to be allocated to the MBS proxy, which can be classified into the following situations.

When the multicast parameter information sent by the MBS server includes the MBS zone identifier, the multicast content identifier, and/or the MBS identifier, the MBS proxy allocates one multicast CID and MBS flow identifier for each MBS zone. The MBS identifier is an SFID in the ASN zone. The MBS identifier may be a Flow ID or the SFID in the course of the interaction between the ASN and the CSN and in the CSN zone, or may be other preset identifier for identifying the MBS. The Flow ID and the SFID are mapped at the MBS proxy, and may be many to one or one to one mapped.

If the MBS request message sent by the MBS server does not contain the MBS GSA ID, the MBS proxy is responsible for allocating the MBS GSA ID, and respectively sending it to the MBS server and the MBS agent.

In the present invention, the MBS Contents ID is unique at the MBS server (when the MBS Contents ID is allocated by the MBS server) or at the MBS Content Provider (when the MBS Contents ID is allocated by the Content Provider), or is unique in one MBS zone. The MBS identifier in the CSN or in the interaction between the CSN and the ASN is unique in the MBS server or in one MBS zone. The multicast CID is unique in the scope of the MBS proxy. The MBS identifier in the ASN is unique in the MBS proxy or in one MBS zone.

In the present invention, one different MBS identifier and a multicast CID are allocated to each MBS zone, and the allocation of the MBS zone cannot beyond the scope of the MBS proxy.

In the present invention, one MBS Contents ID may be associated with one or more MBS zone identifiers, MBS identifiers, and multicast CIDs.

In the method of the present invention, when the MBS server and the MBS proxy are combined as the MBS server, the corresponding interaction between the MBS server and the MBS proxy may be omitted, or, may serve as an interior signaling flow. The configuration of the combined MBS server and MBS proxy may be realized by the MBS server after combination.

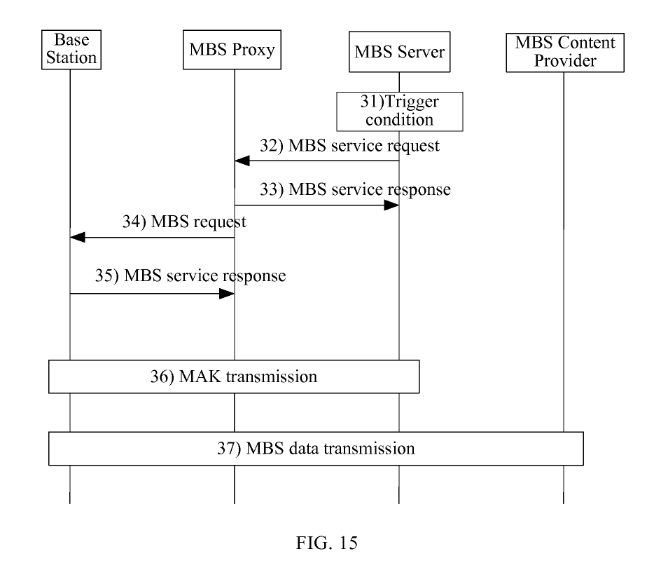

In order to make the method of the present invention more comprehensive, the present invention is, for example, implemented in a wireless communication network realized based on the Wimax technique, i.e. IEEE802.16e protocol, and the details about the implementation and realization of the present invention are shown in FIG. 15, and includes the following steps.

In step 31, the MBS server arranged in network side determines whether the implementation of the MBS is required, and triggers the configuration of network side resource for the coming MBS, and after the requirement is determined, step 32 is performed.

The conditions for the MBS server to determine the implementation of the MBS includes, but not limited to, the MBS server receiving a message from the content provider, which indicates the MBS that is to be started; or after the MBS server requesting the MBS content provider for the MBS and receiving an indication message of the MBS content provider; or after the MBS server receiving an MBS request message from a certain signing subscriber forwarded by the MBS proxy or other function units; or after the MBS server receiving the MBS request message sent from a certain signing subscriber. The message sent to the MBS server by the MBS content provider includes the following parameters: a multicast program content description and its MBS QoS parameter, start time, duration, and/or end time of the MBS, and so on. That is to say, at least one selected from among an MBS QoS parameter, start time, duration, and end time of the MBS may be included.

In step 32, the MBS server sends an MBS request to the MBS proxy, requests the MBS proxy for reserving the network side resource for the MBS. For example, the corresponding MBS request message can be used to bear the MBS request.

When the MBS server determines that the MBS is required to be implemented, the MBS server may allocate an MBS Contents ID and other multicast parameter information for the MBS, sends the MBS request message to the MBS proxy arranged in the network side, so as to reserve the network side resource for the MBS.

The MBS request message sent to the MBS proxy by the MBS server includes the following parameters: the MBS Contents ID, an MBS QoS parameter, an MBS zone identifier, and/or an MBS identifier. Further, the MBS request message may further include other multicast parameter information allocated by the MBS server. The other multicast parameter information may include the MAK and context thereof, the MBS GSA ID, and/or the MBS content provider address.

In this process, in detail, the MBS server or the MBS content provider may be adapted to allocate the MBS Contents ID for the MBS, and the MBS server may be adapted to allocate the MBS identifier for the MBS. And, when the MBS Contents ID is allocated at the MBS server, the MBS Contents ID is unique in the MBS server or the scope of the MBS zone. When the MBS Contents ID is allocated at the MBS content provider, the MBS Contents ID is unique in the MBS content provider or the MBS server or the scope of the MBS zone. The MBS identifier is unique in the MBS server or the scope of the MBS zone.

In step 33, the MBS proxy sends MBS response information to inform the MBS server of the network side resource reservation result.

The MBS proxy reserves resources for the MBS according to the MBS quality parameter included in the received MBS information and local policy information. The MBS response message carries the following parameters: the MBS identifier and/or the MBS Contents ID, the resource reservation result, and/or the MBS zone identifier. Further, the MBS response message may also include the MBS GSA ID.

At the MBS proxy, for the MBS from the same MBS server, the MBS proxy distinguishes different MBSs according to the MBS identifier and/or the MBS Contents ID and/or the MBS zone identifier. For the MBSs from different MBS servers, the MBS proxy distinguishes different MBSs according to the combination of the MBS server address and the MBS identifier and/or the MBS Contents ID and/or the MBS zone identifier. That is, in the situation that the ASN is shared by multiple CSNs, the MBS proxy distinguishes the MBSs according to the combination of the MBS server address and the MBS identifier and/or the MBS Contents ID and/or the MBS zone identifier.

After the MBS proxy receives the MBS request message sent by the MBS server, the MBS proxy allocates one multicast CID and MBS identifier for each MBS zone.

The MBS identifier allocated by the MBS proxy is unique at the MBS proxy, or is unique in the scope of the MBS zone. The multicast CID allocated by the MBS proxy is unique at the MBS proxy. The MBS identifier and the multicast CID allocated by the MBS proxy correspond one-to-one.

If the multicast parameters received by the MBS proxy do not include the MBS GSA ID, the MBS proxy may also allocate the MBS GSA ID to the MBS. Directed to each MBS GSA ID, the MBS proxy generates and allocates a multicast safe key for each MBS zone. The multicast safe key includes the MGTEK and context thereof and/or the MTK and context thereof, and so on. The MGTEK and context thereof and/or the MTK and context thereof may also be transmitted in an independent message to the MBS agent on the base station.

In step 34, the MBS proxy sends the MBS request message including the multicast parameter information to the MBS agent, and requests the MBS agent for reserving the network side resource for the MBS.

The parameters carried in the message may include: the multicast content identifier, the MBS zone identifier, the MBS identifier, the multicast CID, the MBS quality parameter, the MBS GSA ID, the related physical layer parameter, and the multicast safe key and context thereof.

The MBS agent distinguishes different MBSs according to the MBS identifier and/or the MBS zone identifier included in the received MBS request message, and distinguishes different multicast contents according to the MBS identifier and the multicast content identifier and/or the MBS zone identifier.

In step 35, the MBS agent sends the MBS response message to the MBS proxy to inform the MBS proxy of the network side resource reservation result.

The MBS agent implements the receiving control function and reserves the resource at the air interface for the MBS according to the MBS QoS parameter contained in the received MBS information and the local policy information.

At the same time, the MBS agent sends the MBS response message to the MBS proxy, so as to inform the MBS proxy of the network side resource reservation result. The parameters carried in the message may include a resource reservation result, and may also include at least one selected from among the MBS identifier, the multicast CID, the MBS Contents ID, and the MBS zone identifier.

In step 36, the MBS server sends the MBS authorization key and context information thereof to the MBS proxy and the MBS agent.

The MBS authorization key context information includes the MBS GSA ID and/or a lifetime of the MBS authorization key.

The step 36 and the steps 32, 33, 34 and 35 are not ordered in time sequence. That is, the step 36 may be performed before the step 32 or after the step 35. The parameters of the MBS authorization key and context thereof transmitted in step 36 may also be combined in the step 32 and/or step 34 to be transmitted to the MBS proxy and/or the MBS agent, and at this time, the step 36 can be omitted.

In step 37, after the network side completes the configuration of the MBS resource, the configured resource (i.e. the reserved resource) may be used to perform the transmission of the MBS packets.

This step may include the follow processes.

(1) The MBS data achieves the MBS proxy from the MBS server or directly from the MBS content provider. The MBS proxy decodes an IP head of the multicast packet, and the multicast packet is associated with the corresponding multicast parameter information in the MBS proxy by the use of the classifier criteria, i.e. according to the IP address and port number of the packets. The association aims to determine the service flow to which the data stored in the packets belong according to the MBS identifier in the packets, and to determine all the parameters related to the service flow, such as the Multicast CID, the MBS GSA ID, and the MBS zone ID.

(2) The MBS proxy sends the multicast packet to the corresponding data path for transmission according to the completed resource configuration at the network side, thereby transmitting the multicast packet to the MBS agent.

(3) The MBS agent receives the multicast packet on the data path, and maps the packet to the allocated multicast CID for transmission.

The distinguishing can be performed based on the data path identifier or the classifier criteria.

For the MBS, the local subscriber as long as signing the home network can receive the MBS. For the roaming subscriber, only when the roaming network provides the MBS, the subscriber can receive the MBS.

The method for the roaming subscriber to receive the MBS in the roaming network includes as follows. If a corresponding signing relation between the home network and the roaming network allows the subscriber to receive the MBS of the roaming network, the roaming subscriber can directly receive the MBS. Or, if the signing relation does not exist between the home network and the roaming network, or the roaming subscriber intends to join the MBS that is not signed in the home network in the roaming network, the roaming subscriber is required to sign in the roaming network, and after signing the roaming subscriber can receive the corresponding MBS.

Furthermore, it should be noted that those of ordinary skill in the art may understand that all or a part of the steps in the method for realizing the above embodiments may be done by the hardware of the programs and instructions. The programs may be stored in a readable storage media of a computer, such as the ROM/RAM, magnetic disks, and optical disks.

Although the preferred embodiments of the present invention are depicted and illustrated in accompanying with the figures, those of ordinary skill in the art should understand that any changes to the forms and details fall in the scope of the present invention without departing the spirit of the present invention.

What is claimed is:

1. A multicast and broadcast service (MBS) system, comprising:
an MBS server;
a base station, wherein the system is defined with at least one MBS zone, and each of the at least one MBS zone comprises at least one base station;
an access service network (ASN) gateway including an MBS data path function (DPF) adapted to establish, modify, or delete an MBS bearer between the MBS DPF and the base station, and the MBS bearer is adapted to transmit an MBS packet to the base station;
at least one MBS proxy function entity adapted to manage the at least one MBS zone, and each of the at least one MBS zone is managed by one of the at least one MBS proxy function entity.

2. The MBS system according to claim 1, wherein the at least one MBS proxy function entity manages the at least one MBS zone in at least one of the following manners:
controlling at least one of an establishment, a modification, and a deletion of a bearer related to an MBS;
controlling the process of terminal joining and leaving relative to the MBS in the ASN gateway;
allocating parameters and resources related to the MBS;
maintaining an MBS DPF list that belongs to the same MBS zone when each of the at least one MBS zone comprises multiple MBS DPFs;
controlling a transmission of the MBS according to the MBS DPF list;
uniformly scheduling air interface wireless resources related to the MBS in each of the at least one MBS zone;
controlling time synchronization among all base stations and synchronization of time-frequency resources among MBS agents of all the base stations in the same MBS zone, when supporting macro diversity of the MBS; and
performing the MBS related to a resource reservation decision and quality of service (QoS) control according to QoS requirements related to at least one of the MBS, bearer resource status in the ASN, bearer resource status of the MBS zone, and a network access provider (NAP) policy.

3. The MBS system according to claim 1, wherein the MBS DPF is further adapted to implement at least one of the following functions:
transmitting and classifying packets of an MBS;
maintaining an identifier of the at least one MBS proxy function entity in the belonged MBS zone;
MBS accounting;
maintaining a list of MBS agents belonging to the same MBS DPF; and
supporting a synchronization mechanism for an MBS air interface medium access control (MAC) protocol data unit (PDU).

4. The MBS system according to claim 1, wherein the MBS server comprises an MBS controller and an MBS content server, and wherein
the MBS controller is adapted to implement a service control function, and the MBS content server is adapted to implement a service bearer function;
the MBS controller and the MBS content server coexist in the same physical entity or exist in different physical entities respectively.

5. The MBS system according to claim 1, further comprising an authentication, authorization and accounting (AAA) server adapted to save subscriber signing information of the MBS and perform the authentication, authorization and accounting on a terminal;
wherein the MBS controller interacts with the AAA server to realize identity certification and authentication of the terminal, and controls the terminal to join and leave the MBS according to the result of the identity certification and authentication.

6. The MBS system according to claim 1, further comprising a multicast router when an IP multicast protocol is used to bear the MBS, wherein
the multicast router is located in one of the MBS server, the ASN gateway, and an independent entity, and is adapted to distribute the MBS and forward the MBS data according to a multicast address after receiving the MBS data from the MBS content server.

7. The MBS system according to claim 1, wherein the MBS server routes an IP multicast packet to at least one of the ASN gateway and the MBS zone in at least one of the following manners:
transmitting the MBS between the MBS server and the MBS DPF in a manner of IP multicast, wherein the MBS server allocates a multicast address, establishes a corresponding multicast group, builds the MBS into an IP multicast packet according to the allocated multicast address, and routes the IP multicast packet to at least one of the ASN gateway and the MBS zone through a multicast router;
transmitting the MBS between the MBS server and the MBS DPF in another manner of IP multicast, wherein the MBS server allocates a multicast address, establishes a corresponding multicast group, builds the MBS into the IP multicast packet according to the allocated multicast address, transmits the IP multicast packet to at least one border router through a tunnel in a point-to-point manner, and routes the IP multicast packet to at least one of the ASN gateway and the MBS zone by the border router; and
transmitting the MBS between the MBS server and the MBS DPF through the tunnel in the point-to-point manner, wherein the MBS server allocates the multicast address, establishes a corresponding multicast group, builds the MBS into the IP multicast packet according to the allocated multicast address, and transmits the IP multicast packet to at least one of the ASN gateway and the MBS zone through the tunnel in the point-to-point manner.

8. The MBS system according to claim 1, further comprising an MBS content provider adapted to provide an MBS content.

9. The MBS system according to claim 8, wherein the at least one MBS proxy function entity and the MBS DPF are combined to form an MBS proxy adapted to control and forward an MBS program from one of the MBS server and the MBS content provider.

10. The MBS system according to claim 9, wherein the system further comprises an MBS agent adapted to implement at least one of the following functions:
establishing the MBS bearer between the base station and the MBS DPF;
modifying the MBS bearer between the base station and the MBS DPF;
deleting the MBS bearer between the base station and the MBS DPF;
classifying and distributing the MBS packet received from the MBS bearer;
making a statistic on and returning numbers of subscribers receiving the MBS; and
sending MBS data to an air interface according to provided physical resource information if a macro diversity is supported.

11. The MBS system according to claim 10, wherein each of the MBS server, the MBS proxy, and the MBS agent further comprise an MBS QoS management unit adapted to interact messages between the MBS server, the MBS proxy, and the MBS agent when determining that the MBS requires to be implemented, so as to reserve resource for implementing the MBS.

12. The MBS system according to claim 10, further comprising a subscriber management unit arranged in at least one of the MBS server and an AAA server, and adapted to implement at least one of the following functions:
storing MBS at least one of signing information of the subscriber and MBS related information of the subscriber;
authenticating an MBS request initiated by the subscriber; and
providing accounting support to the MBS implemented by the subscriber.

13. The MBS system according to claim 10, further comprising an MBS authorization key (MAK) management unit arranged in at least one of the MBS server and the MBS content provider, and adapted to generate and manage an MBS authorization key and context thereof, wherein
the MBS authorization key is managed in at least one of the following manners:
the MBS content provider generating and managing the MBS authorization key, and sending the MBS authorization key to the MBS proxy;
the MBS content provider generating the MBS authorization key, and sending the MBS authorization key to the MBS server for management; and
the MBS server generating and managing the MBS authorization key.

14. The MBS system according to claim 10, further comprising a session and transmission management unit arranged in the MBS server, and adapted to manage a session and transmission process of the MBS.

15. The MBS system according to claim 10, further comprising an MBS program menu service unit, arranged in at least one of the MBS server and the MBS content provider, and adapted to provide a list of MBS programs in region to a subscriber and trigger a service activation function of subscriber management according to the choice of the subscriber.

16. The MBS system according to claim 10, further comprising a key management unit, arranged in the MBS proxy function entity and the MBS agent, and adapted to manage a safe key and context thereof in the course of implementing the MBS, wherein the safe key comprises at least one of the following: an Group Traffic Encryption Key (MGTEK), an MAK, and an MBS transport key (MTK).

17. The MBS system according to claim 10, wherein the MBS proxy function entity further comprises an MBS zone management unit, adapted to be responsible for the management and maintenance of one MBS zone.

18. A multicast and broadcast service (MBS) zone partitioning method, comprising:
allocating an MBS zone identifier to a base station set having at least one base station; and
providing an MBS in the base station set with the MBS zone identifier.

19. The MBS zone partitioning method according to claim 18, wherein when one MBS is introduced into an MBS system, base stations in a scope covered by the MBS form at least one base station set, a different MBS zone identifier is allocated to each of the at least one base station set, and base stations in each of the at least one base station set share the MBS zone identifier allocated to that base station set.

20. The MBS zone partitioning method according to claim 18, wherein the base stations in an MBS system are partitioned into at least one base station set in advance, and when one MBS is introduced thereto, the MBS is simultaneously introduced into the at least one base station set, a different MBS zone identifier corresponding to the MBS is allocated to each base station set, and base stations in each of the at least one base station set share the MBS zone identifier allocated to that base station set.

21. The MBS zone partitioning method according to claim 18, wherein base stations in an MBS system are partitioned into at least one base station set in advance, a different MBS zone identifier is allocated to each of the at least one base station set, when the MBS is introduced into the MBS system, the MBS is simultaneously introduced into one of the at least one base station set with the allocated MBS identifier, and base stations in the base station set share the MBS zone identifier allocated to that base station set.

22. A method for implementing a multicast and broadcast service (MBS) in a wireless network, comprising:
interacting messages between an MBS server, an MBS proxy comprising an MBS proxy function entity and an MBS data path function (DPF), and an MBS agent when the MBS server determines that the MBS is required to be implemented, so as to a reserve network side resource for the MBS;
using the reserved network side resource to send an MBS program provided by an MBS content provider to a subscriber terminal through one of the following combinations:
the MBS server, the MBS proxy, and the MBS agent, and
the MBS proxy and the MBS agent.

23. The method according to claim 22, wherein the MBS server determines that the MBS is required to be implemented based on one of the following trigger conditions:
after the MBS server receives an indication message sent by the MBS content provider;
after the MBS server requests the MBS content provider for the MBS and receives the indication message of the MBS content provider;
after the MBS server receives an MBS request message from a certain signed subscriber forwarded by one of the MBS proxy and other function unit; and
after the MBS server receives an MBS request message from a certain signed subscriber.

24. The method according to claim 22, wherein the interacting messages between the MBS server, the MBS proxy, and the MBS agent when the MBS server determines that the MBS is required to be implemented, so as to reserve the network side resource for the MBS comprises:
sending, by the MBS server, an MBS request containing a multicast parameter to the MBS proxy, so as to request the MBS proxy to reserve the network side resource for the MBS; and
sending, by the MBS proxy, the MBS request containing the multicast parameter to the MBS agent, so as to request the MBS agent to reserve the network side resource for the MBS.

25. The method according to claim 24, wherein the sending, by the MBS server, the MBS request containing the multicast parameter to the MBS proxy, so as to request the MBS proxy to reserve the network side resource for the MBS further comprises: sending, by the MBS proxy, an MBS response to the MBS server to inform the MBS server of a result of the network side resource reservation; and
information born in the MBS response comprises at least one of the followings: a resource reservation result, an MBS identifier, an MBS zone identifier, an MBS content identifier, and an MBS group security association identifier.

26. The method according to claim 22, wherein the using the reserved network side resource to send the MBS program provided by the MBS content provider to a subscriber terminal comprises:
sending, by MBS content provider, the MBS data to the MBS proxy;
using, by the MBS proxy, the configured multicast resource to send the multicast data to one or more MBS agents in a corresponding MBS zone;
receiving, by the MBS agent, the multicast data, and mapping the multicast data to an allocated multicast CID to send to a subscriber terminal.
